(19) United States
(12) Patent Application Publication
(10) Pub. No.: US 2012/0037244 A1
(43) Pub. Date: Feb. 16, 2012

(54) AIR PUMP FACILITATOR

(76) Inventor: MORRIS OSTROWIECKI, (US)

(21) Appl. No.: 12/855,857

(22) Filed: Aug. 13, 2010

(51) Int. Cl. F16K 15/20

(52) U.S. Cl. 137/231

(57) ABSTRACT

A nipple for connecting any conventional pipe to any conventional part.

Also disclosed is an air pump facilitator for facilitating the pumping of air into an air tire.

Also disclosed is an INLINE air pressure gauge for measuring the pressure being pumped through said air hose.

Also disclosed is an electronic INLINE air pressure gauge for measuring the pressure being pumped through said air hose.

The present invention relates to a facilitator for facilitating the pumping of air into the tire of a bicycle, motor cycle or car tire. The facilitator basically comprises a flexible nylon pipe (or urethane or teflon pipe) or any flexible pipe or hose, one end of which is connected to an air pump connecting means and the other end of which is connected to a valve connecting means (Schrader, Presta or Dunlop). The facilitator further comprises an “INLINE air pressure indicator” coupled to said air hose along a central portion of said flexible air hose for constantly measuring the pressure in the tire while pumping air into the tire.

The present invention further comprises means for coupling an air hose, gas hose, or hydraulic hose to any other part using only one extra part.

### BACKGROUND OF THE INVENTION

Many portable air pumps presently on the market do not have an air hose for connecting to the air valve of a bicycle, motorcycle or a car tire. Having an air hose allows air to be pumped into a tire much more easily and stably than without an air hose. Furthermore, many conventional air pumps do not have an air pressure gauge which makes it impossible to know how much air is in the tire.

Still further, presently, conventional floor type air pumps as well as some portable air pumps have a rubber air hose for facilitating the pumping of air into a tire. However, these rubber air hoses are relatively large in diameter and have thick walls not only to be able to withstand high air pressure (120 psi) but also to be able to physically connect the air hoses to the air pump, making them heavy and bulky. Further, each end of the air hose is coupled to the air pump and to the air valve connector using multiple parts making the air pump more expansive, bulkier as well as heavier.

### SUMMARY OF INVENTION

A major object of the present invention is to provide an air pump facilitator which overcomes the drawbacks mentioned above.

Another object of the present invention is to provide an air pump facilitator which facilitates the pumping of air into an air tire, by making it easier to pump air into the tire.

Another object of the present invention is to provide an air pump facilitator which can be easily connected to most air pumps presently available on the market;

Another object of the present invention is to provide an air pump facilitator having an “INLINE” pressure indicator;

Another object of the present invention is to provide an air pump facilitator which has a very thin, strong, light flexible air hose which has an inner diameter just big enough to allow a sufficient air flow rate during normal air pumping using conventional bicycle air pumps;

Another object of the present invention is to provide an air pump facilitator which has a hose made of thin nylon or urethane having an inner diameter of between 1-3 mm and an outer diameter of between 2-4 mm, respectively, and preferably an inner diameter (ID) of 2.5 mm and an outer diameter (OD) of 4 mm such as made by Pisco Co. Ltd.

Another object of the present invention is to provide an air pump facilitator comprising a very thin light air hose having an air pump connecting portion coupled to one end of said hose and an air valve connecting portion coupled to the other end of said hose, said connecting portions respectively being coupled to said respective ends of said air hose by means of glue which adheres both to vinyl and metal, such as manufactured by Semedine super glue product no. AX-023.

Another object of the present invention is to provide an air pump facilitator comprising a very thin light air hose having an air pump connecting portion coupled to one end of said hose and an air valve connecting portion coupled to the other end of said hose, said connecting portions being coupled to said respective ends of said air hose by means of a cylindrically shaped nipple frictionally inserted inside the respective ends of said hose and the respective ends of said hose being frictionally inserted inside cylindrical holes in said portions.

Another object of the present invention is to provide an air pump facilitator comprising a very thin light air hose having an air pump connecting portion coupled to one end of said hose and an air valve connecting portion coupled to the other end of said hose, said connecting portions respectively being coupled to said respective ends of said air hose by means of a cylindrically shaped nipple, said nipple having an outer diameter which is slightly larger than the inner diameter of said hose and each of said nipples being inserted into respective ends of said air hose so as to lock said connecting portions to said ends of said air hose, each of said nipples having a through hole formed through the center thereof;

Another objective of the present invention is to provide a nipple portion for coupling any conventional part to any conventional air hose, gas hose, or hydraulic hose, the nipple comprising a round sleeve portion and a round outwardly facing radial ring portion integrally formed with said sleeve portion, the sleeve portion having an outer diameter which is slightly larger than the inner diameter of the hole in the hose, and the ring portion having an outer diameter which is greater than a hole in said conventional part through which the conventional air hose is to be inserted, the ring portion preventing the sleeve from being pulled through said conventional part, and the sleeve portion having at least one outwardly facing cylindrical cone shaped protrusion along the outer surface thereof for gripping the hose. This nipple can be used for coupling any conventional hose to any conventional part.

Another objective of the present invention is to provide an American type (Schrader) air valve connector having one part thereof which is a conventional part of a British (Dunlop) type air valve, thereby reducing the manufacturing cost of the Schrader connector;

Another objective of the present invention is to provide a French (Presta) type air valve connector having two cylindrical parts for allowing one part to swivel with respect to the other part.

Another objective of the present invention is to provide a INLINE air pressure gauge coupled to a central portion of an air hose according to the present invention;

Another objective of the present invention is to provide a INLINE air pressure gauge coupled to a central portion of an air hose of the air pump facilitator according to the present invention;

Another objective of the present invention is to provide an INLINE air pressure gauge having very few parts; and

Another objective of the present invention is to provide a digital INLINE air pressure gauge coupled to a central portion of said air hose.

### BRIEF DESCRIPTION OF THE DRAWINGS

FIG. 1A-1D shows a side view, a front view, a back view and a side cross sectional view at line II-II of FIG. 1A of a nipple 21 used for connecting any part to any hose according to the present invention;

FIG. 2 shows a side cross sectional view of a conventional part 22 having a conventional type hose 23 coupled thereto using the nipple 21 according to the present invention;

FIG. 3 shows a perspective view of a first embodiment of an air pump facilitator 44 according to the present invention;

FIG. 4 shows a perspective view of a second embodiment of an air pump facilitator 45 according to the present invention;

FIG. 5 shows a perspective view of a third embodiment of an air pump facilitator 46 according to the present invention;

FIGS. 6A-6D show a side view, front view, a back view and a side cross sectional view at line II-II of FIG. 2A of an air pump connecting portion 40 of the facilitator 45 and 46 according to the present invention;

FIG. 7A shows a side cross sectional view of the air pump connecting portion 40 having the air hose 23 and the nipple 21 mounted therein;

FIG. 7B shows a side cross sectional view of an air pump connecting portion 4000 according to another embodiment of the present invention;

FIG. 8A-8E show a perspective view, a side view, a front view, a back view and a side cross sectional view at line II-II in FIG. 8B of a first part 51 of the American Schrader type air valve connector 50 according to the present invention;

FIG. 9A-9D show a side view, a front view, a back view and a cross sectional view at line II-II in FIG. 9A of a second part 52 of the American Schrader type air valve connector 50 according to the present invention;

FIG. 10A-10E show a perspective view, a side view, a front view, a back view and a cross sectional view at line II-II in FIG. 9B of a third part 53 of the American Schrader type valve connector 50 according to the present invention;

FIG. 11A-11B show a front view and a side view of a one way air valve diaphragm 54 of the American Schrader type valve connector 50 according to the present invention;

FIG. 12A shows a side cross sectional view of all the parts of the Schrader air valve 50 assembled together according to the present invention;

FIG. 12B shows a side cross sectional view of all the parts of the Schrader air valve 50 assembled together and having a Schrader air valve 17 mounted therein;

FIG. 13A-13D show a side view, a front view, a back view and a cross sectional view at line II-II in FIG. 13A of a first part 61 of the French type Presta air valve connecting portion 60 according to the present invention;

FIG. 14A-14D show a side view, a front view, a back view and a cross sectional view at line II-II in FIG. 14A of a second part 62 of the French type Presta air valve connecting portion 60 according to the present invention;

FIG. 15A shows a side cross sectional view of the Presta air valve connecting portion 60 with all the parts assembled therein before the extending end 61e of the first part 61 is folded according to the present invention;

FIG. 15B shows a side cross sectional view of the Presta air valve connecting portion 60 with all the parts assembled therein after the extending end 61e of first part 61 is folded according to the present invention;

FIG. 15C shows a side cross sectional view of the Presta air valve connecting portion 60 shown in FIG. 15B further having a Presta type air valve 18 mounted therein;

FIGS. 16A-16D show a side view, a front view, a back view and a side cross sectional view at line II-II of FIG. 16A of a first part 71 of a REVERSIBLE air valve connecting portion 70 according to the present invention;

FIGS. 17A-17D show a side view, a front view, a back view and a side cross sectional view at line II-II of FIG. 17A of a second part 72 of a REVERSIBLE air valve connecting portion 70 according to the present invention;

FIGS. 18A-18D show a side view, a front view, a back view and a side cross sectional view at line II-II of FIG. 18A of a third part 73 of a REVERSIBLE air valve connecting portion 70 according to the present invention;

FIGS. 19A-19D show a side view, a front view, a back view and a side cross sectional view at line II-II of FIG. 19A of a fourth part 74 of a REVERSIBLE air valve connecting portion 70 according to the present invention;

FIGS. 20A-20E show a perspective view, a side view, a front view, a back view and a side cross sectional view at line II-II of FIG. 20B of a fifth part 75 of a REVERSIBLE air valve connecting portion 70 according to the present invention;

FIG. 21 shows a side cross sectional view of the first, second and fourth parts of the REVERABLE air valve connecting portion 70 in the assemble form;

FIG. 22 shows a side cross sectional view of the REVERABLE air valve connecting portion 70 in the assemble form with the third part 73 mounted in the second part 72 in the Presta valve mounting direction and with a Presta type air valve 18 mounted therein;

FIG. 23 shows a side cross sectional view of the REVERABLE air valve connecting portion 70 in the assembled form with the third part 73 mounted in the second part 72 in the Schrader air valve mounting direction with a Schrader type air valve 17 mounted therein;

FIG. 24A-24E show a perspective view, a side view, a front view, a back view, and a side cross sectional view at line II-II of FIG. 24B of an outer cylindrical portion 81 of an INLINE air pressure gauge 80 according to the present invention;

FIG. 25A-25E show a perspective view, a side view, a front view, a back view, and a side cross sectional view at line II-II of FIG. 25B of a cap portion 82 of an INLINE air pressure gauge 80 according to the present invention;

FIG. 26A-26E show a perspective view, a side view, a front view, a back view, and a side cross sectional view at line II-II of FIG. 26B of an inner cylindrical portion 83 of an INLINE air pressure gauge 80 according to the present invention;

FIG. 27A-27E show a perspective view, a side view, a front view, a back view, and a side cross sectional view at line II-II of FIG. 27B of a piston 12 of an INLINE air pressure gauge 80 according to the present invention;

FIG. 28A shows a side cross sectional view of an INLINE air pressure gauge 80 according to the present invention with the piston 12 in the zero air pressure position;

FIG. 28B shows a side cross sectional view of an INLINE air pressure gauge 80 according to the present invention with the piston 12 in the full air pressure position;

FIG. 28C shows a side cross sectional view of a digital INLINE air pressure gauge 90 according to the present invention;

FIG. 29 shows a side cross sectional view of the air pump connecting portion 40 of FIG. 7A further having a one way air valve mounted therein;

FIGS. 30A-30D shows a side view, a front view, a back view and a side cross sectional view of a second part 41 of the air pump connecting portion 400 according to the present invention;

FIG. 31A shows a side cross sectional view of a Schrader air valve connecting portion 500 according to another embodiment of the present invention; and

FIG. 31B shows a side cross sectional view of a Schrader air valve connecting portion 500 of FIG. 31A having a Schrader air valve 17 mouted therein.

### DETAILED DESCRIPTION OF THE PREFERRED EMBODIMENTS;

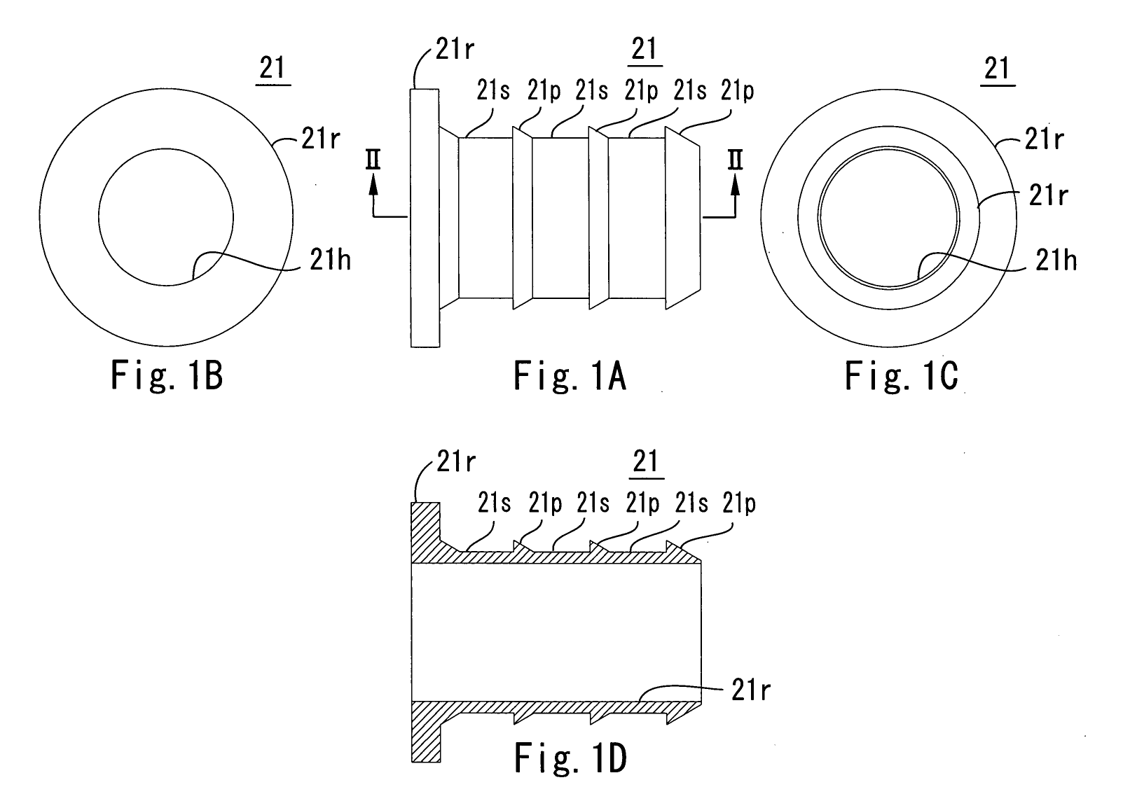

FIG. 1A-1D shows a side view, a front view, a back view and a side cross sectional view at line II-II of FIG. 1A of a nipple 21 used for connecting any conventional part to any conventional hose according to the present invention. Referring to the Figs., numeral 21 generally designates a nipple having a cylindrical sleeve portion 21s and an outwardly facing radial ring portion 21r integrally formed with the sleeve portion 21s in the radial direction of the sleeve portion 21s and along one end thereof Numeral 21p designates three radial cone shaped protrusion integrally formed with the sleeve portion 21s along the outer surface thereof The larger diameters of the cone shaped protrusions 21p face towards the ring portion 21r of the nipple 21. With the larger diameters of the cone shaped portions 21p facing towards the ring portion 21r, two objectives are accomplished. The first being that it is much easier to push the nipple 21 into the end of the hose 23 and the other objective is that once the end of the hose 23 is mounted onto the sleeve portion 21s of the nipple 21, the protrusions 21p “bite” into (dig into) the skin of the hose 23, grabbing the hose and preventing the nipple 21 from being pulled out of the end of the hose 23. Numeral 21h designates a hole through the centre of the nipple 21 in the axial direction thereof. The outer diameter of the ring portion 21r is larger than the outer diameter of the protrusions 21p and the protrusions 21p have a larger diameter than the sleeve portion 21s.

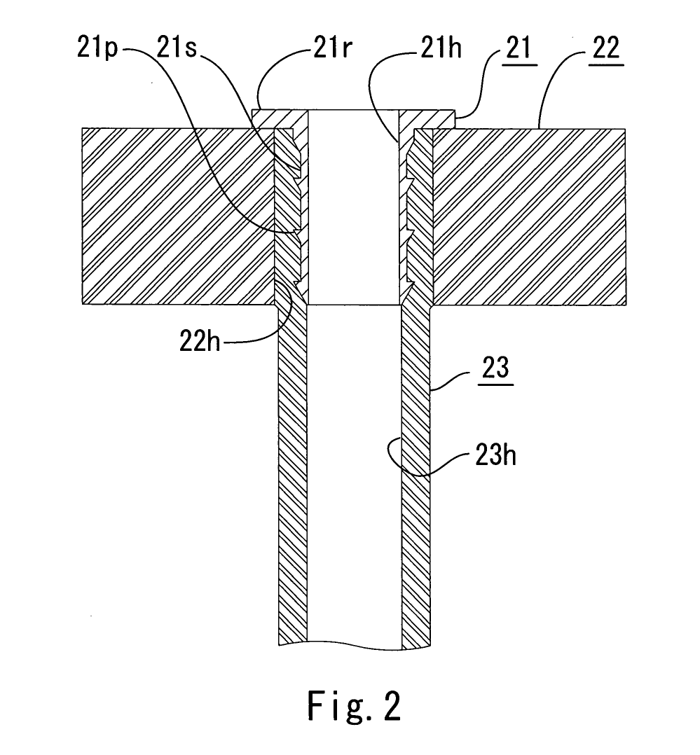

FIG. 2 shows a side cross sectional view of a conventional part 22 connected to a conventional flexible hose 23 using the nipple 21 according to the present invention. Referring to the Fig., numeral 23 designates a flexible hose made from polyurethane, polypropylene, nylon, etc., numeral 22 designates a conventional part which may be a part of a bigger part in any air pump, hydraulic system, pneumatic system, air conditioning system, pneumatic drill in a dentist office, air conditioning system in a car, etc., numeral 21 designates a nipple portion used for coupling the part 22 with the hose 23 according to the present invention.

Numeral 22h designates a through hole formed through the conventional part 22. The inner diameter of the hole 22h is the same as or larger than the outer diameter of the hose 23. The inner diameter of the hole 22h is larger than the outer diameters of the sleeve portion 21s and protrusions 21p of the nipple 21. The outer diameter of the ring portion 21r of the nipple 21 is larger than the inner diameter of the hole 22h in the part 22. The outer diameter of the sleeve portion 21s of the nipple 21 and the protrusions 21p are larger than the inner diameter of the hole 23h in the hose 23.

The other end of the sleeve portion 21s of the nipple 21 is tapered 21t for facilitating the insertion of the nipple 21 into the hose 23.

Preferably, the length of the hole 22h in the part 22 should be at least as long as the length of the sleeve portion 21s of the nipple 21. Also, preferably the inner diameter of the hole 21h through the sleeve portion 21s of the nipple 21 is substantially the same as the hole in the hose 23.

The first coned protrusion 21p is formed at the extending end of the nipple 21, the cone 21p provides a tapered surface for also facilitating the insertion of the nipple 21 into the hose 23.

To mount the hose 23 in the part 22, first one end of the hose 23 is fed through the hole 22h in the part 22 until the front end of the hose 23 protrudes out of the other end of the hole 22h. Next, the extending front end of the sleeve portion 21s of the nipple 21 is pushed into the hole 23h in the end of the hose 23 until the ring portion 21r of the nipple 21 butts up against the extending end of the hose 23, thereby causing the hose portion of the hose 23 in which the sleeve portion 21s is inserted into to stretch outwards and become larger than the inner diameter of the hole 22h in the part 22. At this time, the cone shaped protrusions 21p dig into a portion of the inner walls of the hose 23 making it difficult to pull the nipple 21 back out of the hose 23. Next, the hose 23 is pulled back through the part 22 by pulling backwards on the other end of the hose 23 to cause the one end of the hose 23 having the sleeve portion 21s inserted therein to be pulled into the hole 22h in the part 22, whereby the hose portion of the hose 23 having the sleeve portion 21s of the nipple portion 21 inserted therein gets squeezed inside the hole 22h in the part 22, as well as further squeezing the cone shaped protrusions into the skin of the hose to better grip the hose 23 by the sleeve portion 21s of the nipple 21. Furthermore, since the outer diameter of the ring portion 21r of the nipple 21 is larger than the hole 22h in the part 22, it becomes impossible to pull the nipple 21 through the hole 22h in the part 22, thereby permanently locking the hose 23 in the part 22. Furthermore, the hose 23, the part 22 and nipple 21 are hermetically sealed with each other.

It should be noted that the nipple 21 can be used to hermetically couple any conventional hose to any conventional part where gas pressure, oil pressure, water, etc., is present. For example, in the automotive industry, the nipple 21 can be used to connect hoses in the vehicles power steering system, the hydraulic brake system, the air conditioning system, etc. Similarly for commercial airplanes, boats, etc.

Furthermore, that the cone shaped protrusions 21p need not be cone shaped, and can be any other shape such as semi-cylindrical, square, etc.

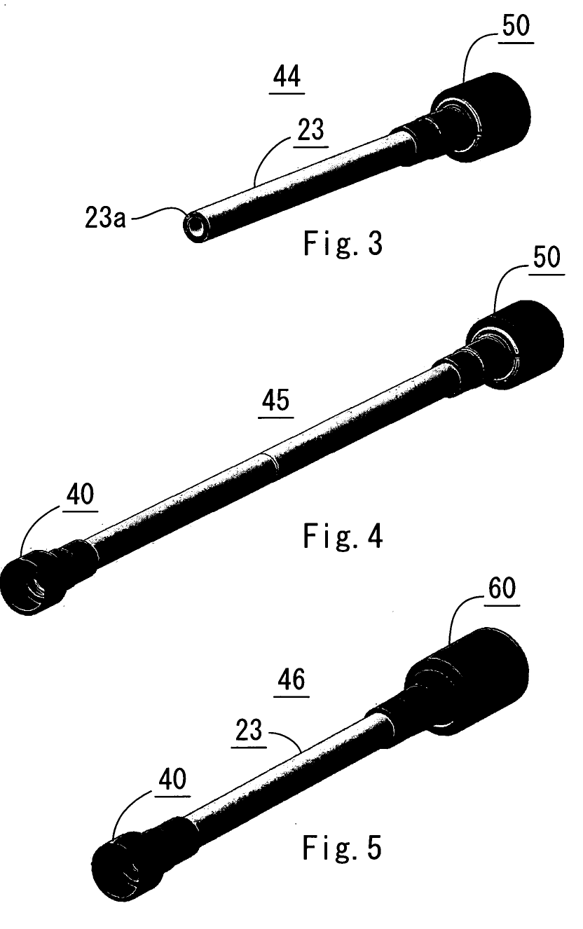

FIG. 3 shows a perspective view of a first embodiment of the air pump facilitator 44 according to the present invention. Referring to the Fig., numeral 23 designates a high pressure flexible air hose made of nylon, urethane, Teflon, rubber, plastic, polypropylene, polyethylene, or any other material suitable for high pressures, numeral 50 designates a American Schrader type air valve connecting portion which is mounted on one end of the air hose 23 and the other end 23a of the air hose 23 is used for mounting the facilitator 44 to a conventional air pump.

One such high pressure hose is made by Pisco Co. Ltd. The preferred inner diameter of the air hose is 2.5 mm and the outer diameter is approximately 4 mm (i.e. Pisco catalogue part number polyurethane tube UB0425(5/32) or nylon NA0425(5/32)). The outer diameter of the air hose 23 (i.e. 4 mm) is smaller than the outer diameter of the French (Presta) type air valve (i.e. 5.12 mm). This hose is relatively thin and has a much smaller outer diameter than air hoses presently used with conventional air pumps and, accordingly, is much lighter, as well as being stronger and cheaper. This size hose of 2.5×4.0 mm also allows the use of one part normally used in British type air valves to be used for an American Schrader type of air connecting portion valve as will be explained hereafter, as well as minimizing the weight and reducing the number of parts required. Furthermore, it allows for a very simple construction of a French type air valve connector having few parts and which can swivel with respect to the air hose 23 by using only 4 parts. Still further, the hose 23 has an outer diameter of approximately 4 mm which is just the right size to fit into the air pump connector commonly found in conventional air pumps for mounting the conventional air pump on a French type air valve. Accordingly, with this diameter hose, one end of the hose 23a can itself become the connecting portion for the facilitator 50, thereby minimizing the number of parts used with the facilitator 44.

The inner diameter of 2.5 mm for the air hose 23 allows for a sufficient air flow rate to pass therethrough when pumping up a bicycle air tire using conventional bicycle air pumps. Namely the molecular friction between air particles is not substantial to hamper air flow in the air hose 23 during pumping.

FIG. 4 shows a perspective view of an air pump facilitator 45 comprising a high pressure air hose 23 having a Schrader air valve connecting portion 50 mounted on one end thereof and an air pump connecting portion 40 mounted on the other end thereof.

FIG. 5 shows a perspective view of an air pump facilitator 46 comprising a high pressure air hose 23 having a Presta air valve connecting portion 60 mounted on one end thereof and a air pump connecting portion 40 mounted on the other end thereof according to the present invention.

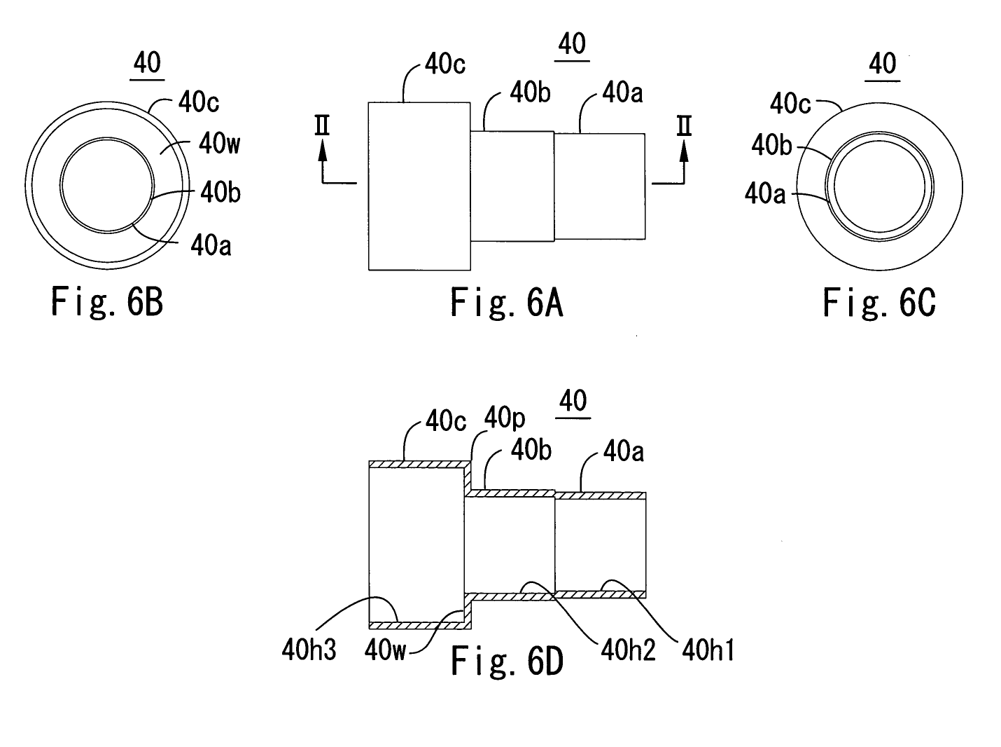

FIG. 6A-6D show a side view, front view, a back view and a side cross sectional view at line II-II of FIG. 6A of an air pump connecting portion 40 for connecting the facilitator 45 or the facilitator 46 to a conventional air pump according to the present invention. Referring to the Figs., the air pump connecting portion 40 is cylindrical in shape and comprises a first, second and third concentric cylindrical portion 40a, 40b and 40c integrally formed with each other. The second cylindrical portion 40b has an inner diameter 40h2 which is smaller than the inner diameter 40h1 of the first cylindrical portion 40a and the third cylindrical portion 40c has a larger inner diameter 40h3 than the inner diameter 40h2 of the second cylindrical portion 40b. The wall thickness of the three cylindrical portions is the same. Accordingly, the second cylindrical portion 40b has an outer diameter which is larger than the outer diameter of the first cylindrical portion 40a and the third cylindrical portion 40c has a larger outer diameter than the second cylindrical portion 40b.

The third cylindrical portion 40c has an outer diameter which is 7.3 mm, which is the same as the outer diameter of a Schrader American type of air valve. Furthermore, the third cylindrical portion 40c has a length of 4.5 mm which is shorter than the length of the length of the hole in a rubber sleeve portion commonly found in a conventional air pump (not shown) used for clamping the American Schrader type of air valve. Accordingly, when the third portion 40c (hereinafter referred to as air pump mounting portion 40c or mounting portion 40c) is placed inside the hole in a rubber portion of a conventional air pump connector (not shown) for the Schrader type air valve, when the rubber portion (which is usually 10 mm long) inside a conventional air pump is clamped (i.e. squeezed by a conventional thumb lever), it will squeeze the mounting portion 40c in a way that the mounting portion 40c will never come out of the conventional air pump under normal bicycle pumping pressure. More specifically, the rubber sleeve inside a conventional air pump will not only frictionally grab the outer walls of the cylindrical portion 40c, but, more importantly, also clamp around the point 40p where the outer diameter of the wall changes from a larger diameter of the third cylindrical portion 40c to a smaller outer diameter of the second cylindrical portion 40b.

The first and second cylindrical portions 40a, 40b are provided for connecting the air hose 23 to the air pump connecting portion 40 by using the nipple 21 according to the present invention.

In the case of using the Pisco urethane tube model no. UB0425(5/32), which has an OD=4 mm and ID=2.5 mm, the inner diameters of the first and second cylindrical portions 40a, 40b (hereinafter collectively referred to as air hose attaching means 100) of the air pump portion 40 are made 4.0 mm and 4.2 mm, respectively. The length of the first and second cylindrical portions 40a, 40b is 5 mm each.

The outer diameter of the cone shaped protrusions 21p on the sleeve portion 21s and the ring portion 21r of the nipple 21 are made 3.2 mm and 4.5 mm, respectively. The length of the ring portion 21r and sleeve portion 21s is 0.5 mm and 5.0 mm, respectively. The outer diameter of the sleeve portion 40s is 3 mm and the through hole in the nipple 21 is 2.5 mm, which is the same as the size of the hole inside the air hose 23.

Accordingly, the outer diameter of the hose 23 is the same as the inner diameter of the hole 40h1 in the first cylindrical portion 40a and the inner diameter of the hole 40h2 in the second cylindrical portion 40b in the air pump connecting portion 40 is larger than the outer diameter of the hose 23. However, the hole 40h2 in the second cylindrical portion 40b is smaller than the outer diameter of the hose 23 when the sleeve portion 21s of the nipple 21 is inserted therein.

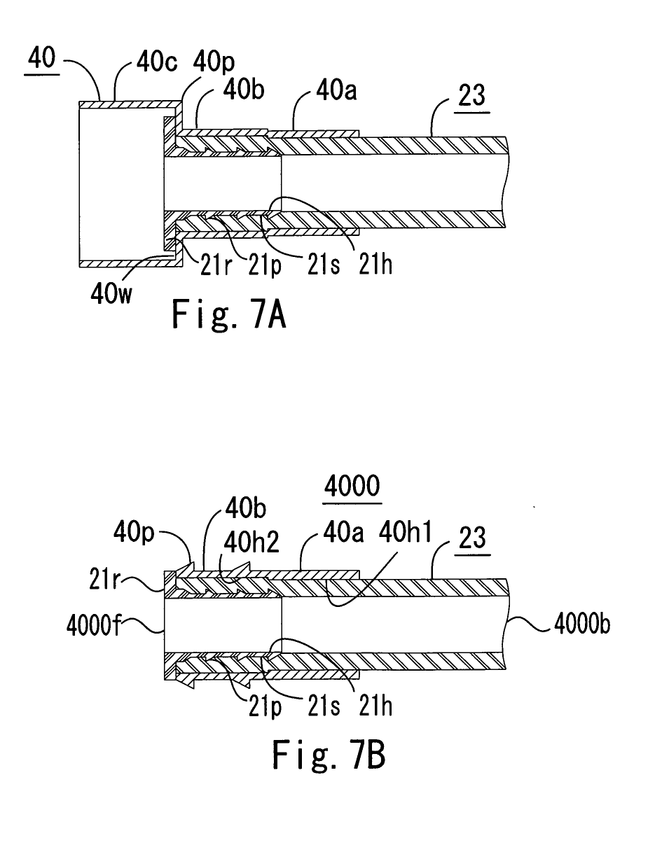

FIG. 7A shows a side cross sectional view of the air pump connecting portion 40 having the air hose 23 and the nipple 21 mounted therein. Referring to FIG. 7A, to join the air pump connecting portion 40 to the hose 23 using the nipple 21 of the present invention, first the one end of hose 23 is inserted through the hole inside the first cylindrical portion 40a until it extends out of the front end of the third cylindrical portion 40c of the air pump connecting portion 40. Then, the nipple 21 is pushed into the extending end of the hose 23 until the sleeve portion 21s is completely inserted inside the hose 23 and the ring portion 21r of the nipple 21 butts up against the end of the hose 23, Next, the hose 21 is pulled back through the air pump connecting portion 40 until the one end of the hose 23 is inside only the first and second portions 40a, 40b of the air pump connecting portion 40 and the ring portion 21r of the nipple 21 butts up against the inner wall 40w joining the second and third cylindrical portions 40b, 40c. thereby preventing the hose, and the nipple from being pulled out any further out of the pump connecting portion 40. At this time, the portion of the hose 23 inside the cylindrical portion 40b is squeezed, and due to the elastic nature of the hose 23, the hose conforms to the space between the inner walls of the hole 40h2 in cylindrical portion 40b and the protrusions 21p formed on the sleeve portion 21s and the outer walls of the sleeve portion 21s of the nipple 21, thereby permanently locking the hose 23 in the air pump connecting portion 40 as well as providing an airtight seal therebetween.

The inner diameter of the cylindrical portion 40a of the air pump connecting portion 40 is the same as the outer diameter of the hose 23 and is provided to decrease stress on the hose portion inside the cylindrical portion 40b in which the nipple 21 is inserted due to the user of the facilitator pulling and twisting on the air hose 23 while pumping air into a bicycle air tire.

It should be noted that the cylindrical portion 40a of the air pump connecting portion 40 is not essential for the air hose attaching means 100.

The first and second cylindrical portion 40a, 40b of the air pump connecting portion 40 in conjunction with the nipple 21 hereinafter will be referred to as air hose attaching means 100, and the same structure will be used for connecting the air hose 23 to any other parts of the present invention, according to the present invention.

The air pump connecting portion 40 preferably is formed of stainless steel using a conventional CNC controlled lathe machine, and, has a wall thickness of 0.1-0.5 mm. Alternatively, the connecting portion 40 can be formed of brass, aluminium, or any other metal or from plastic using conventional plastic injection molding techniques.

It should be noted that the present invention is not limited to the size or type air hose disclosed above (i.e. PISCO-UB0425(5/32), and that any other size or type of hoses can be used, as long as the dimensions of the corresponding nipples and air hose attaching means 100 of the connectors used therewith are chosen accordingly.

FIG. 7B shows a side cross sectional view of an air pump connecting portion 4000 according to another embodiment of the present invention. In the Fig., the same numerals will be used to describe the same or similar parts as the parts of the air pump connecting portion 40 shown in FIG. 7A.

Referring to FIG. 7B, Numeral 4000 an air pump connecting portion which comprises two cylindrical portion 40a, 40b integrally formed with each other. Numeral 40p designates two cone shaped radial protrusions integrally formed with the cylindrical portions 40a, 40b along the outer surface thereof The radial cone shaped protrusions 40p face the back end 4000b of the cylindrical portion 40b. Namely, the bigger diameter of the cone shaped protrusions 40p are facing the back end 4000b of the cylindrical portion 40b. The inner diameters of the hole in the cylindrical portions 40a, 40b is the same as and slightly bigger than the outer diameter of the hose 23, respectively. The outer diameter of the cylindrical portions 40a, 40b is 5.0 mm and the outer diameter of the protrusions 40p is 5.2 mm. The inner and outer diameters of the hose 23 are 2.5 mm and 4.0 mm, respectively. The inner and outer diameters of the sleeve portion 21s of the nipple 21 are 2.5 mm and 3.0 mm, respectively. The outer diameter of the cone shaped protrusions 21p is 3.2 mm. The outer diameter of the ring portion 21r is 4.5 mm.

To assemble the air pump connecting portion 4000, first one end of the air hose 23 is inserted into the hole 40h1 from the back end 4000b of the cylindrical portion 40b until the hose protrudes out of the front end 4000f of the cylindrical portion 40b. Next, the sleeve portion 21s of the nipple 21 is inserted into the extending end of the hose 23 until the ring portion 21r butts up against the extending end of the hose 23. Next, the hose 23 is pulled backwards through the cylindrical portion 40a until the ring portion 21r of the nipple 21 butts up against the front end 4000f of the cylindrical portion 40b, thereby permanently locking the hose 23 in the cylindrical portion 40b.

Accordingly, since the outer diameter of the cylindrical portions 40a, 40b is 5.0 mm and the cone shaped protrusions 5.2 mm, the air pump connecting portion 4000 can be inserted into any conventional air pump having a conventional rubber portion having a 5 mm hole therein for mounting a conventional French Presta type air valve therein. Namely, since the outer diameter of the thread 18t of a conventional Schrader air valve 18 is 5.0 mm, the air pump connecting portion 4000 can be inserted into the hole in a conventional rubber portion in a conventional air pump where the Presta air valve would normally be inserted when pumping up a tire having a Presta type air valve.

It should be noted that the protrusions 40p need not be limited to a cone shape, and can be semi-cylindrical, or any other shape.

The air pump connecting portion 4000 can be used instead of the air pump connecting portion 40 in any of the air pump facilitators of the present invention.

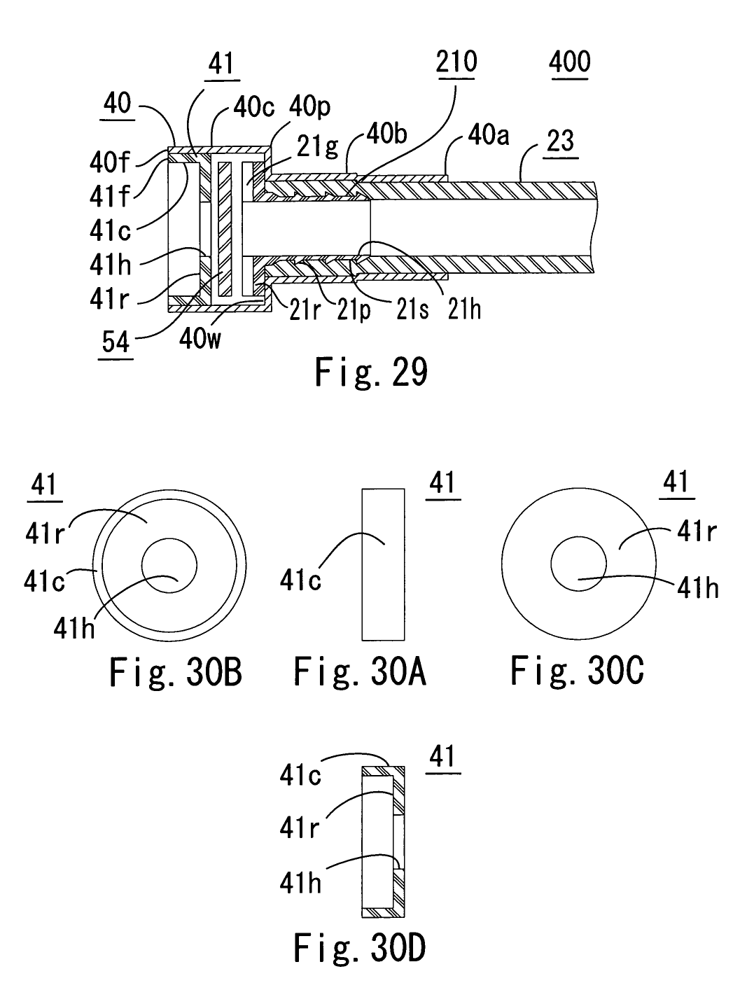

FIG. 29 shows a side cross sectional view of the air pump connecting portion 400 which is similar to the air pump connecting portion 40 shown in FIG. 7A but further having a one way air valve mounted therein.

FIG. 30 shows a side view, a front view, a back view and a side cross sectional view of a second part 41 of the air pump connecting portion 400 according to the present invention.

Referring to FIG. 29 and FIGS. 30A-30D, numeral 400 generally designates an air pump connecting portion which is the same as the air pump connecting portion 40 but further having a disc like diaphragm 54 (shown in FIG. 11A and 11B) mounted therein, as well as a round cap portion 41 frictionally inserted into the centre of the cylindrical portion.

The cap 41 comprises a cylindrical portion 41c and an inwardly facing radial ring portion 41r integrally formed with said cylinder portion 41c along one end thereof Numeral 41h designates a round hole formed in the centre of the ring portion 41r. The length of the cylindrical portion 41c of the cap portion 41 is 2 mm shorter than the length of the cylindrical portion 40c of the air pump connecting portion 40. The outer diameter of the cylindrical portion 41c is slightly larger than the inner diameter of the third cylindrical portion 40c of the air pump connecting portion 40. To assemble the air pump connecting portion 400, first the air hose 23 and a nipple 210 are mounted therein as described above with respect to the air pump connecting portion 40.

The nipple 210 is the same as the nipple 21 except that the ring portion 21r has a pair of radial grooves 21g formed along the front surface thereof

Next, the diaphragm 54 is inserted into the third cylindrical portion 40c of the cylindrical air connecting portion 40. Next the cap 41 is pressure fitted inside the third cylindrical portion 40c of the air pump connecting portion 40 using a conventional press machine (not shown). The ring portion 41r of the cap 41 faces inwards towards the nipple 210 and the front end 40f, 41f of the air pump connecting portion 40 and the cap 41 are aligned with each other. The space inside the cap 41 facing the outer end is necessary for fitting the air pump connecting portion 400 inside a conventional air pump Schrader connecting mounting position.

Numeral 21g designates radial grooves formed on the front surface of the ring portion 21r of the nipple 210 to allow air to flow between the diaphragm 54 and the front side of the ring portion 21r of the nipple 210, so that air can flow through the air pump connecting portion 400 when pumping air therethrough in one direction but not allowing air to flow through in the other direction.

The Schrader air valve connecting portion 50 comprises a first part 51, a second part 52, third part 53 and a fourth parts 54 and will be described hereinafter.

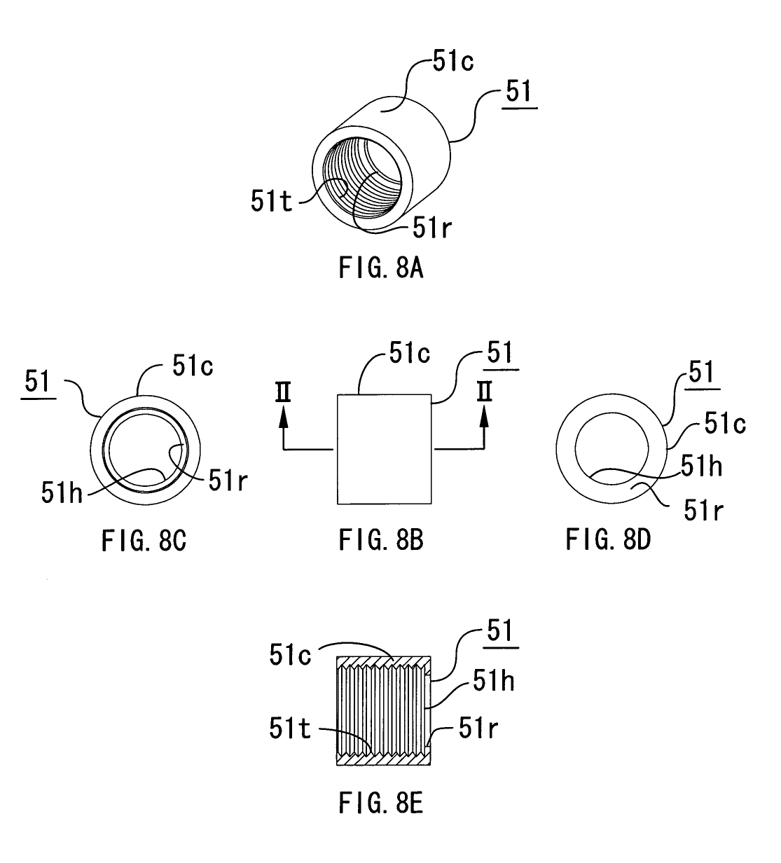

FIGS. 8A-8E show a perspective view, a side view, a front view, a back view and a side cross sectional view at line II-II of FIG. 8B of a first part 51 of the Schrader type air valve connecting portion 50 according to the present invention.

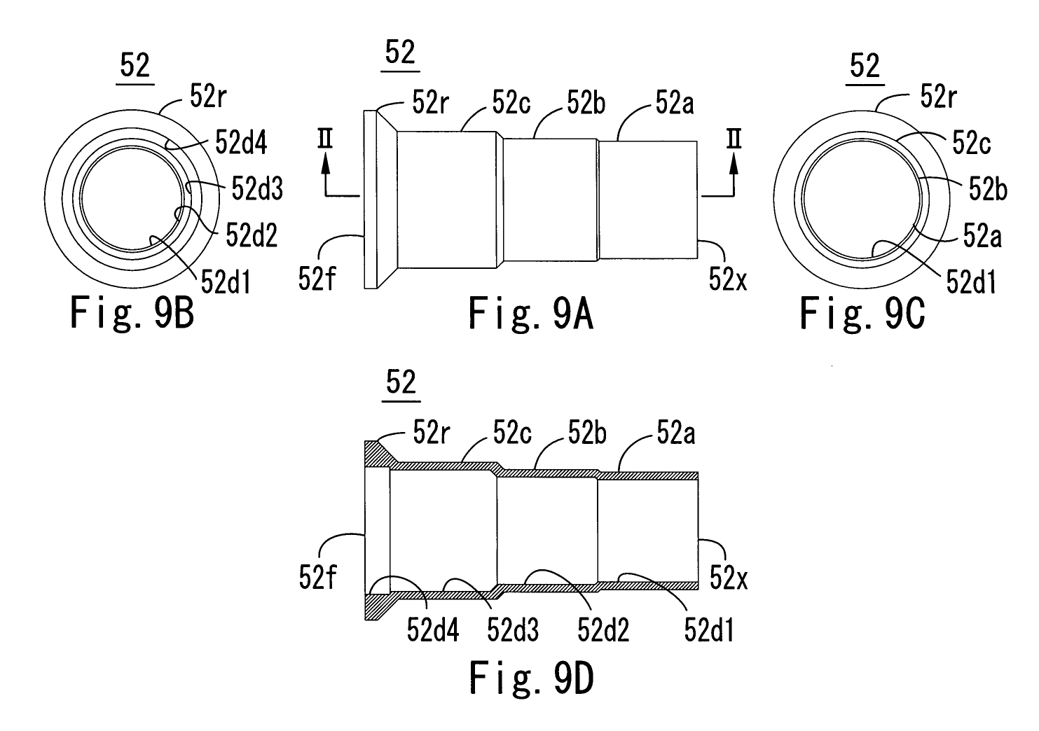

FIGS. 9A-9D show a side view, front view, back view and a side cross sectional view of a second part 52 of the Schrader type air valve connecting portion 50 according to the present invention.

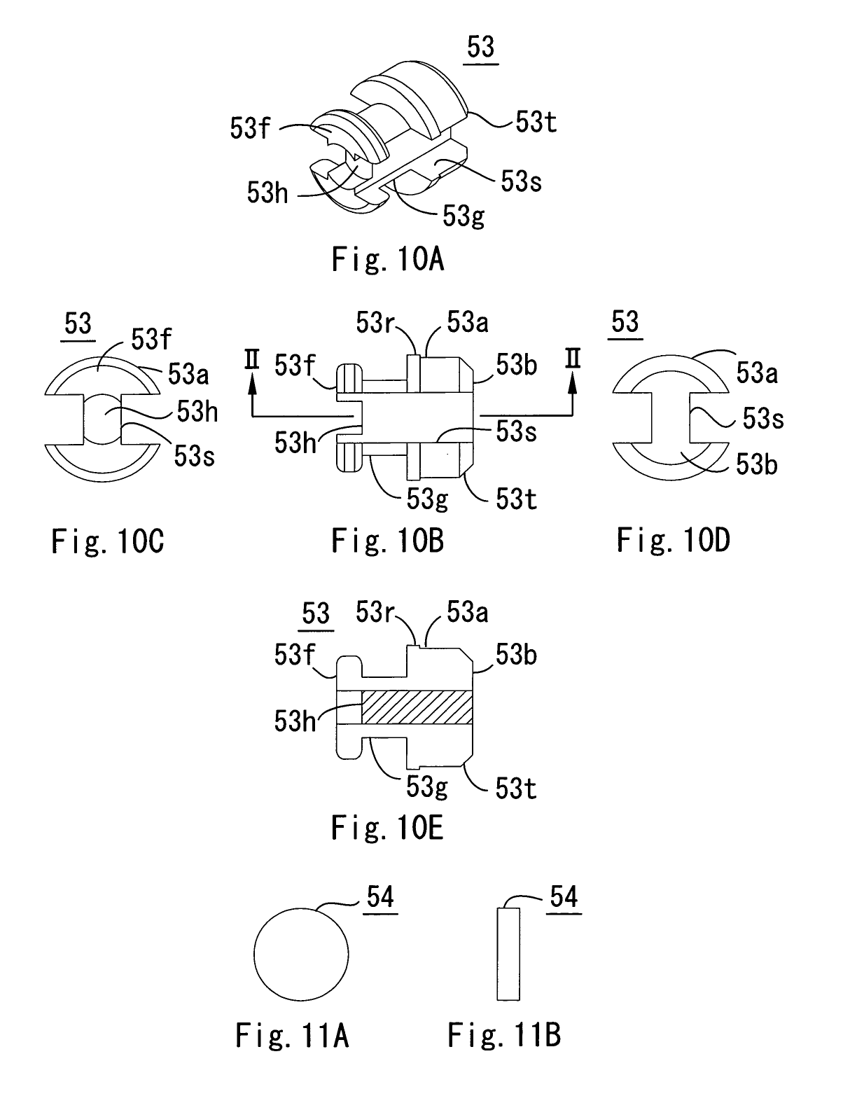

FIGS. 10A-10E show a perspective view, a side view, front view, back view and a side cross sectional view at line II-II of FIG. 10B of a third part 53 of the Schrader type air valve connecting portion 50 according to the present invention.

FIG. 11A and 11B show a front and side view of a disc like diaphragm 54 used for allowing air to flow in one direction and stopping air from flowing in the other direction inside the Schrader air valve connecting portion 50 according to the present invention.

Referring to FIGS. 8A-8E the first part 51 is identical in size and shape to a conventional part which is used in British (Dunlop) type air valves. There are millions of these manufactured yearly and are the most prevalent type of air valve in Japan. Although the British type valve is no longer used in Canada or the U.S., it is still manufactured by the millions in the far east and accordingly, is very cheap to buy, very light simple and strong.

For some strange reason this part 51 fits perfectly on the American type air valve. It seems to be too much of a coincidence that the diameter and thread pitch of this part 51 from a British type air valve fits exactly the diameter and thread pitch of a conventional type of American/Schrader type air valve, especially in view that the thread pitch is not a standard pitch found on conventional nuts and bolts. It is the inventors opinion that the inventor of the American/Schrader type air valve had used old discarded British valves while inventing the American/Schrader type of air valve, and that that inventor simply adapted the same diameter and pitch (not that it matters to anyone except to the inventor of this invention) of the British Dunlop type air valve for the American/Schrader type air valve.

Referring to FIGS. 8A-8E, the first part 51 comprises a cylindrical portion 51c having a thread 51t formed along the inner wall thereof and an inwardly facing radial ring portion 51r integrally formed with the cylindrical portion 51c along one end thereof. The ring portion 51r has a through hole 51h formed therethrough at the center thereof. The exact shape and size part as the first part 51 is found in every British type air valve, and accordingly, need not be manufactured specifically for this Schrader type connecting portion 50 of the present invention.

Referring to FIGS. 9A-9D, numeral 52 generally designates the second part of the Schrader type air valve. The second part 52 is cylindrically in shape and comprises a first, second and third concentric cylindrical portion 52a, 52b and 52c integrally formed with each other. The second cylindrical portion 52b has a larger diameter than the first cylindrical portion 52a and the third cylindrical portion 52c has a larger diameter than the second cylindrical portion 52b. The wall thickness of the first, second and third cylindrical portions 52a, 52b and 52c is the same and preferably is 0.1-0.5 mm thick when formed of stainless steel, brass or aluminium, so as to minimize the weight thereof.

The first and second cylindrical portions 52a and 52b of the second part 52 are identical to the first and second cylindrical portions 40a, 40b of the air pump connecting portion 40, and accordingly, in conjunction with the nipple 21 provide the function of air hose attaching means 100.

The third cylindrical portion 52c of the second part 52 has an outer diameter which is 5.3 mm, which is slightly smaller than the size of the hole 51h in the ring 51r of the first part 51 of the Schrader type connecting portion 50. Namely, slightly smaller than the hole 51h in the conventional part found in all Dunlop/British type air valves.

The third cylindrical portion 52c has an outwardly facing ring portion 52r integrally formed therewith along the extending end thereof. The through hole inside the cylindrical portions 52a, 52b, 52c, and ring portion 52r are 52d1, 52d2, 52d3 and 52d4, where 52d1<52d2<52d3<52d4, the smallest diameter d1 being 4 mm, d2 being 4.2 mm, d3 being approximately 4.8 mm and d4 being larger than 4.8.

The outer diameters of the ring 52r and the cylindrical portion 52c of the second part 52 are slightly smaller than the inner diameters of the cylindrical portion 51c and the hole 51h of the first part 51, respectively, so that the second part 52 can partly slide into the first part 51. The outer diameter of the ring 52r of the second part 52 is larger than hole 51h in the first part 51, so that the second part 52 cannot slide right through the first part

Although it would normally not be important to mention dimensions in patent applications, there are a number of constraints that are present (i.e. the size of the hole in the rubber connector (not shown) in an air pump (not shown) to connect to a Presta type of air valves (which is approximately 5 mm in diameter) defines the size of the air hose 23 to be substantially 4-5 mm as well. Furthermore, the size of the hole in a conventional rubber connector in conventional air pumps for mounting an American Schrader type air valve limits the size of the third cylindrical portion 40c of the air pump connecting portion 40 to be 7 mm and, accordingly, to use the nipple of the present invention to connect the hose 23 to the air pump connecting portion, the hose is limited to be less than 7 mm and preferably 4 mm. Accordingly, all the dimensions of all the parts must be formed based on the hose being substantially 4 mm and the conventional part 51.

Although this invention is not limited to these dimensions and parts, it is convenient to use the conventional part 51 from a cost point of view. Since the part 51 is already manufactured in large quantities, it can be bought at a very low cost.

A preferred hose is a high pressure hose made by PISCO-UB0425(5/32), the outer diameter (OD) being 4 mm and the inner diameter (ID) being 2.5 mm.

Referring to FIGS. 10A-10E, numeral 53 generally designates a third part of the Schrader air pump connecting portion 50. The third part 53 comprises a round shaft 53a having two axial slots 53s formed therein in the axial direction thereof The shaft 53a further has a round groove 53g formed therein in the radial direction thereof for mounting a conventional rubber O ring 151 therein.

Numeral 53r designates a radial ring integrally formed with the shaft 53a along the outer surface thereof on one side of the radial groove 53g.

The shaft 53a on one side of the radial groove 53g (hereinafter referred to as the back end 53b of the shaft 53a) has an outer diameter which is slightly larger than the inner diameter 52d3 in the second part 52 of the Schrader valve connecting portion 52, so that it may be pressure fitted therein. The back end 53b of the shaft 53a is tapered 53t, so that it may facilitate the pressure insertion of the shaft 53a into the third cylindrical portion 52c of the second part 52, as well as to allow for better air flow through the Schrader air valve connecting portion 50 during the pumping of air therethrough. The shaft 53a on the other side of the radial groove 53g (hereinafter referred to as the front end 53f of the shaft 53a) has an outer diameter which is smaller than the hole inside a Schrader air valve 17, so that it can slide thereinto to press on the air release pin 17p inside the Schrader air valve 17.

The front end 53f of the shaft 53a has a round hole 53h formed at the center thereof, the hole 53h extending from the front end 53f of the shaft 53a to where the groove 53g is formed. This hole 53h is provided for allowing the front end of the activation pin 17p inside the Schrader air valve 17 to fit therein, so that the activation pin 17p is only pressed when the extending end of the Schrader air valve 17 presses against the O ring 151 mounted in the groove 53g, thereby ensuring that no air escapes prematurely when mounting the Schrader air connecting portion 50 on a Schrader air valve 17.

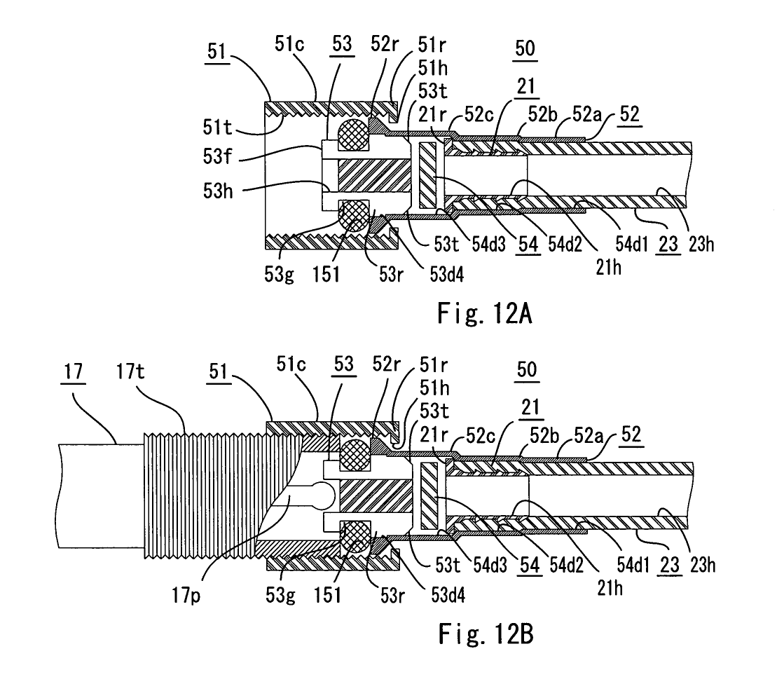

FIG. 12A shows a side cross sectional view of the Schrader connecting portion 50 in the assembled form.

FIG. 12B shows a side cross sectional view of the Schrader connecting portion 50 in the assembled form with a Schrader type air valve 17 mounted therein.

To assemble the Schrader air valve connecting portion 50, first the first part 51 is mounted on the second part 52 of the Schrader connecting portion 50 with the cylindrical portion 51c of the first part 51 facing towards the front end 52f of the second part 52. Next, one end of the air hose 23 is inserted into the part 52 from the back end 52x of the second part 52, until the end of the hose 23 extends out of the front end 52f of the second part 52. Next, the sleeve portion 21s of the nipple 21 is pressed into the extending end of the hose 23 until the ring portion 21r of the nipple 21 butts up against the extending end of the hose 23. Next, the hose 23 is pulled backwards from the back end 52x of the second part 52 until the hose 23 and the nipple 21 are inside the cylindrical portion 52b, 52a and the ring portion 21r is adjacent to the wall between the cylindrical portions 52b and 52c of the second part 52, thereby permanently locking the hose 23 and the nipple 21 inside the second part 52 of the Schrader air valve connecting portion 50, so that the hose 23 is hermetically sealed and locked inside the part 52.

Next, the rubber diaphragm 54 is inserted inside the cylindrical portion 52c of the part 52. Next, the third part 53 is mounted in the part 52. Namely, the back end 53b of the shaft 53a is pressed to slide into the third cylindrical portion 52c of the second part 52, until the ridge 53r fits inside the hole 52d4 in the ring 52r of the second part 52. Preferably, the thickness of the diaphragm is 1 mm and the distance between the inner back end 53b of the shaft 53 and the ring portion 21r of the nipple 21 inside the second part 52 should be 2 mm, so that the diaphragm 54 has a 1 mm space to move back and fourth to allow air to flow therearound.

Next the O ring 151 is mounted inside the groove 53g of the third part 53.

The outer diameter of the diaphram 54 is smaller than the inner diameter 52d3 in the third cylindrical portion 52c of the second part 52, so that air can flow around it in one direction, i.e. through the hose 23, the nipple 21, into the cylindrical portion 52c in the second part 52, through the slots 53s in the third part 53 and into the Schrader air valve 17. When air tries to flow in the other direction through the connecting portion 50, the diaphragm 54 is pressed against the front surface of the ring portion 21r of the nipple 21 to prevent air coming out of the air tire.

Referring to FIG. 12B, the first part 51 is screwed onto the Schrader type air valve 17 by swivelling the first part 51 clock wise until the front end of the valve 17 presses against the O ring 151 to hermetically seal the Schrader air valve 17 in the connecting portion 50. Namely, the thread 17t of the Schrader valve 17 is screwed into the thread 51t of the first part 51 when the first part 51 is turned clock wise with respect to the thread on the Schrader valve 17. The first part 51 is free to rotate with respect to the second part 52 until the Schrader valve 17 is completely screwed into the connecting portion 50. At this time the front end 53f of the third part 53 pushes the activation pin 17p of the Schrader valve slightly in to allow air to flow in and out of the air tire (not shown) to which the Schrader air valve 17 is mounted on. At this time the diaphragm 54 is pushed backwards against the ring portion 21r of the nipple 21 to seal the Schrader valve connecting portion 50 and to prevent air from escaping out of the tire. On the other hand, when the air pressure in the hose 23 is greater than the air pressure in the tire, the diaphragm moves towards the third part 53 and allows air to flow from the air pump (not shown) connected to the facilitator 45 through the slots 53s into the air tire.

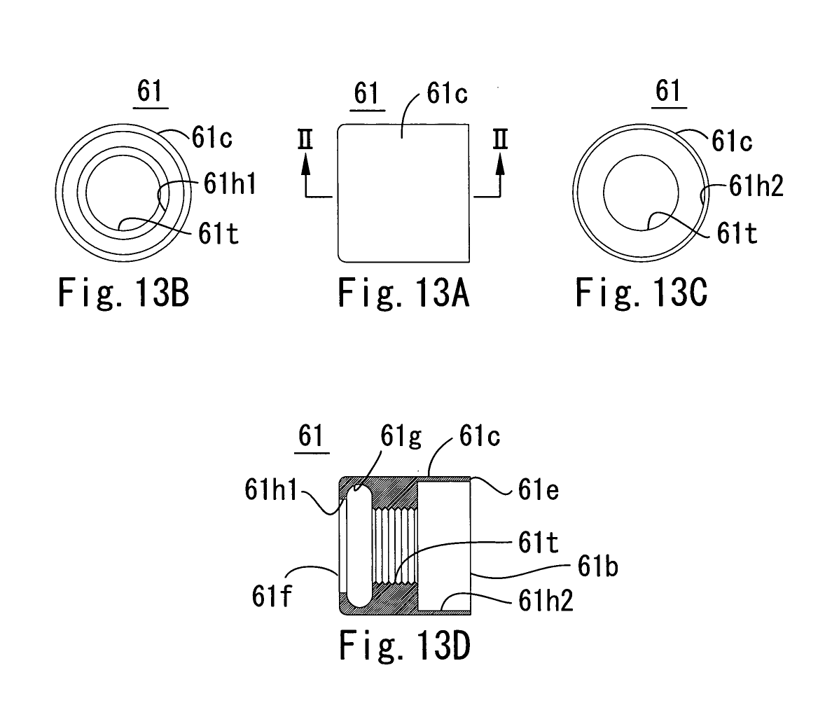

FIG. 13A-13D show a side view, a front view, a back view and a cross sectional view at line II-II in FIG. 13A of a first part 61 of the French type Presta air valve connecting portion 60 according to the present invention.

Referring to FIGS. 13A-13D, the first part 61 is cylindrical in shape and has a front hole 61h1 formed at the front end 61f thereof and a back hole 61h2 formed through the back end 61b thereof. Numeral 61t designates a thread portion formed in the inner surface of the central portion of the cylindrical part 61 and numeral 61g designates a groove formed on the inside walls of the part 61 between the front hole 61h and the thread portion 61t. The front hole 61f is slightly larger than the shaft portion 18s of the Presta air valve 18, the thread portion 61t has the same diameter and pitch as the thread 18t on the front end of a conventional Presta type air valve 18. The groove 61g is provided for housing an O ring 152 therein for hermetically sealing the Presta type air valve 18 inside the first part 61 of the Presta air valve connecting portion 60. Numeral 61h2 designates a cylindrically shaped hole formed through the back end 61b of the first part 61 which extends from the back end 61b of the part 61 to the back end of the thread portion 61t. The inner diameter of the hole 61h2 is larger than the inner diameters of the thread portion 61t.

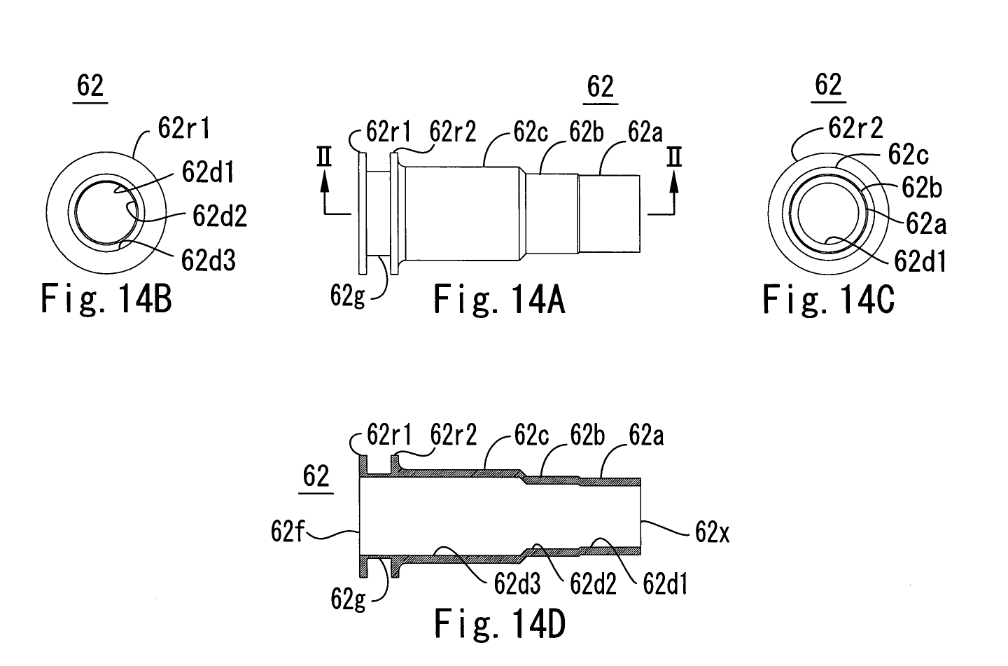

FIG. 14A-14D show a side view, a front view, a back view and a side cross sectional view at line II-II in FIG. 14A of a second part 62 of the French type Presta air valve connecting portion 60 according to the present invention,

Referring to FIG. 14A-14D, numeral 62 generally designates a second part of the Presta air valve connecting portion, numeral 62a, 62b, 62c designate a first, second and third cylindrical portions coaxially formed with each other, the cylindrical portion 62b is larger than the cylindrical portion 62a and the cylindrical portion 62c is larger than the cylindrical portion 62b. The inner diameter of the cylindrical portion 62a and 62b are 4.0 mm and 4.2 mm, respectively, and together provide the function of, in conjunction with the nipple 21, air hose attaching means 100, similar to the cylindrical portions 52a, 52b of the second part 52 of the Schrader type air valve connecting portion 50.

The inner diameter of the hole 62d3 in the cylindrical portion 62c is larger than the outer diameter of the release nut 18n of the Schrader type air valve 18, so that the release nut 18n can fit therein. The length of the cylindrical portion 62c of the second part 62 is slightly longer than the pin 18p of the Presta air valve, so that the pin 18p and the nut 18n can fit therein.

Numerals 62r1 and 62r2 designate a first and second outwardly extending radial rings integrally formed with the third cylindrical portion 62c along the outer surface thereof The first ring 62r1 is formed on the extending end of the cylindrical portion 62c and the second ring 62r2 is formed along a central portion of the cylindrical portion 62c. The rings 62r1, 62r2 and the portion of the third cylindrical portion 62c between the rings 62r1 and 62r2 serve to house an O ring 153.

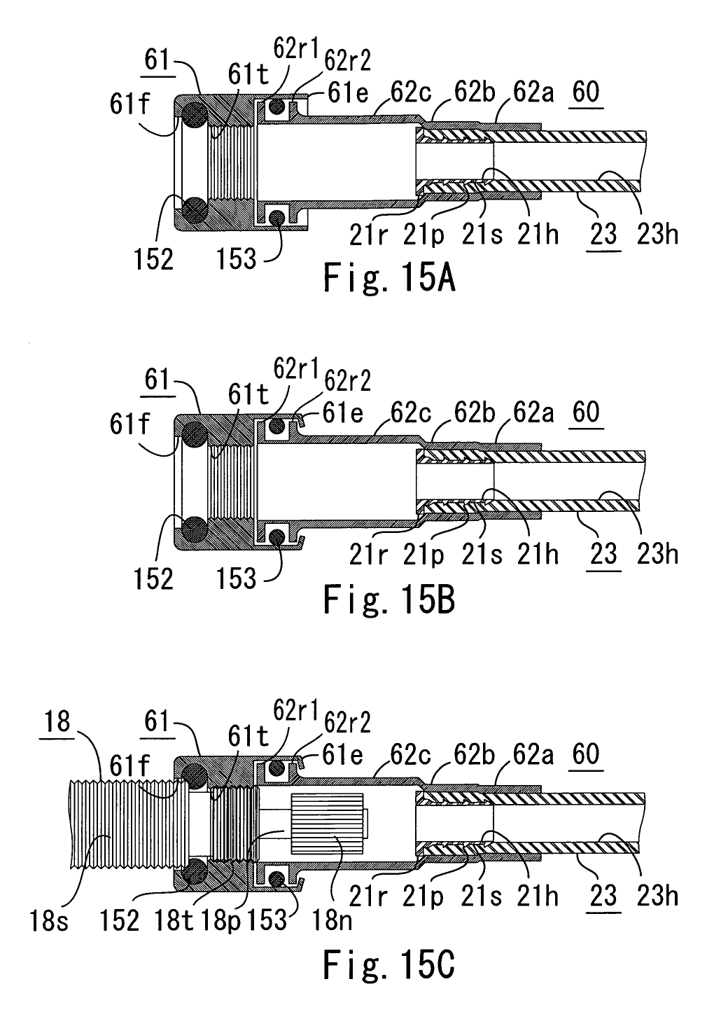

FIG. 15A shows a side cross sectional view of the Presta air valve connecting portion 60 with all the parts assembled therein before the extending end 61e of first part 61 is folded according to the present invention.

FIG. 15B shows a side cross sectional view of the Presta air valve connecting portion 60 with all the parts assembled therein after the extending end 61e of first part 61 is folded according to the present invention.

FIG. 15C shows a side cross sectional view of the Presta air valve connecting portion 60 with all the parts assembled therein after the extending end 61e of first part 61 is folded and with a Presta air valve 18 mounted therein.

Referring to FIGS. 15A-15B, to assemble the Presta air valve connecting portion 60, first an O ring 152 is inserted in the groove 61g in the first part 61. Next, an O ring 153 is mounted between the rings 62r1-62r2 formed on the cylindrical portion 62c of the second part 62.

Next, the cylindrical portion 62c having the O ring 153 mounted thereon is inserted into the hole 61h in the back end of the first part 61 until both rings 62r1 and 62r2 are inside the hole 61h in the part 61. The inner diameter of the hole 61h is larger than the inner diameter of the hole in the thread portion 61t. The outer diameter of the rings 62r1 and 62r2 is slightly smaller than the inner diameter of the hole 61h in the first part 61.

The inner diameter ID of the O ring 153 should be slightly larger than the outer diameter of the cylindrical portion 62c and the outer diameter of the O ring 153 should be slightly larger than the inner diameter of the hole 61h in the first part 61. The axial distance between the rings 62r1 and 62r2 should be slightly larger than the thickness of the O ring 153.

Accordingly, since the inner diameter of the O ring 153 is larger than the outer diameter of the cylindrical portion 62c and since the thickness of the O ring 153 is less than the distance between the inner surfaces of the radial rings 62r1 and 62r2, the O ring 153 is free to ‘float’ around on the cylindrical portion 62c (i.e. when the O ring 153 is rotated with respect to the part 62, almost no friction exists between the O ring 153 and the part 62). However, since the outer diameter of the O ring 153 is slightly larger than the inner diameter of the hole 61h in the first part 61, a hermetic air seal is formed therebetween, thereby preventing pressurized air from escaping between the first and second parts 61, 62 when pumping air through the Schrader connecting portion 60, while at the same time allowing the part 61 to freely swivel with respect to the part 62 when screwing the Presta air valve connecting portion 60 onto a Presta type air valve 18. The length of the hole 61h is longer than the axial distance between the outer surfaces of the two radial rings 62r1 and 62r2.

Next, the front end of the part 62 is inserted into the hole 61h in the back end 61b of the part 61. Namely, the ring 62r1 of the second part 62 is inserted into the hole 61h of the first part 61 until the ring 62r1 butts up against the inner end of the thread portion 61t. At this time, the extending end 61e of the part 61 extends past the second ring 62r2 of the second part 62. Next, the extending end 61e of the first part 61 is folded inwards (using a press machine or using a rolet and a lathe) to lock the part 62 inside the part 61.

Next, one end of the hose 23 is inserted into the hole 62d1 in the back 62b of the part 62 and pushed through the part 62 until the end of the hose 23 extends out of the front end 61f of the first part 61. Next, the nipple 21 is inserted into the extending end of the hose 23 until the end of the hose portion 23 butts up against the ring portion 21r of the nipple 21. Next, the hose 23 is pulled back through the parts 61, 62 until the nipple 21 and the hose portion 23 having the sleeve portion 21s of the nipple 21 inserted therein lock inside the cylindrical portion 62b of the part 62.

Since the outer diameter of the ring portion 21r is 4.5 mm and since the inner diameter of the thread portion 61t is 6.2 mm, the hose 23 and the nipple 21 can easily pass through the part 61 and into the part 62, allowing for easy assembly of the French type connecting portion 60. Furthermore, since the ring portion 21r of the nipple has an outer diameter of 4.5 mm, the ring portion 21r cannot slide into the hole 62d2 in the second cylindrical portion 62b of the second part 62, and accordingly, permanently hermetically locks the hose 23 in the second part 62 of the Presta type air valve 60. Accordingly the cylindrical portions 62a, 62b provide the function of air hose attaching means 100.

Accordingly, the Presta valve connecting portion 60 has only 4 parts, namely the first part 61, the second part 62 and the O rings 152 and 153.

Referring to FIG. 15C, which shows a Presta air valve 18 mounted inside the Presta air valve connecting portion 60, the conventional Presta air valve comprises a shaft 18s, a thread portion 18t, a pin 18p and a release nut 18n. The release nut 18n must first be partly unscrewed to allow air to flow in and out of the Presta air valve 18. The thread 18t of the Presta valve 18 is screwed into the thread 61t in the first part 61 until the front end of the shaft portion 18s presses against the O ring 152 to provide an air tight seal therebetween. At this time, air can be pumped into the Presta air valve and no air will escape between the parts 61, 62, due to the O ring 153.

The Presta air valve connecting portion 60 can also be used to pump up an air tire having a British type Dunlop air valve, since the thread size and the thread pitch of the Dunlop and Presta air valves is substantially the same.

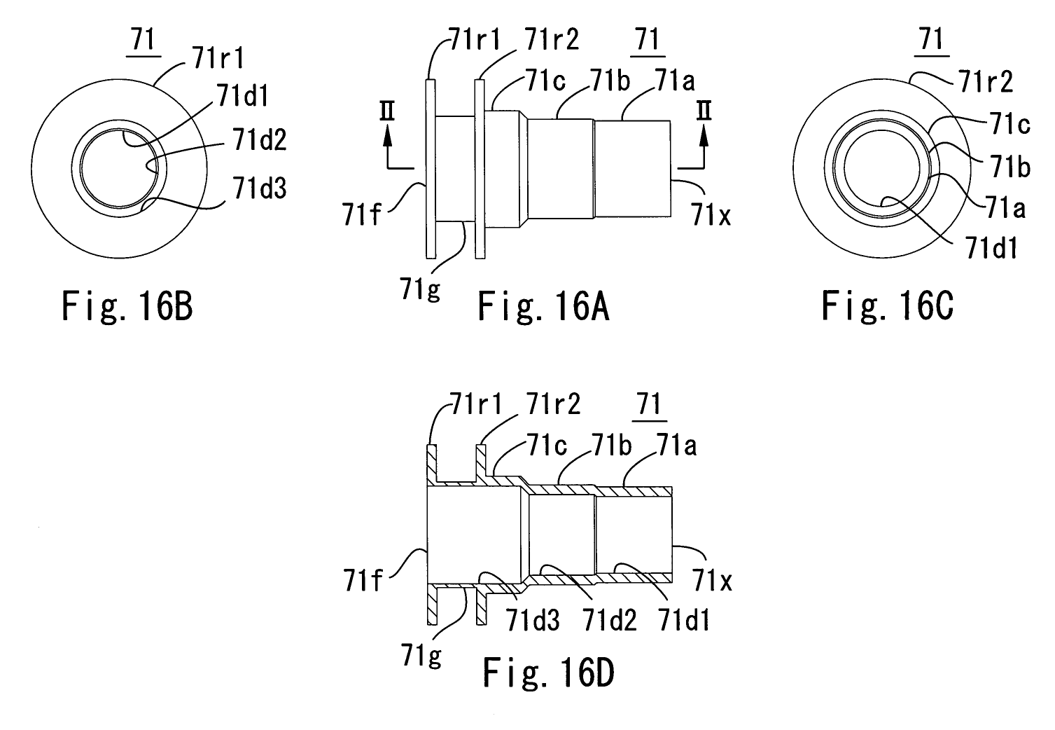

FIGS. 16A-16D show a side view, a front view, a back view and a side cross sectional view at line II-II of FIG. 16A of a first part 71 of a REVERSIBLE air valve connecting portion 70 according to the present invention. Referring to the Figs., numeral 71 generally designates a first part which is substantially cylindrical in shape. Numerals 71a, 71b and 71c designate a first, second and third coaxial cylindrical portions integrally formed with each other. The first cylindrical portion 71a has a smaller inner diameter than the second cylindrical portion 71b and the second cylindrical portion 71b has a smaller inner diameter than the third cylindrical portion 71c. Numeral 71r1 and 71r2 designate two radial outwardly facing rings integrally formed with the third cylindrical portion 71 c along the outer surface thereof. The ring 71r1 is formed at the extending end of the third cylindrical portion 71c and the ring 71r2 is formed along a central part of the cylindrical portion 71c.

The first and second cylindrical portion 71a and 71b have an inner diameter of 4.0 and 4.2 mm, respectively, and, in conjunction with the nipple 21 provide the same function of air hose attaching means 100, similar to the cylindrical portions 40h1 and 40h2 of the air pump connecting portion 40.

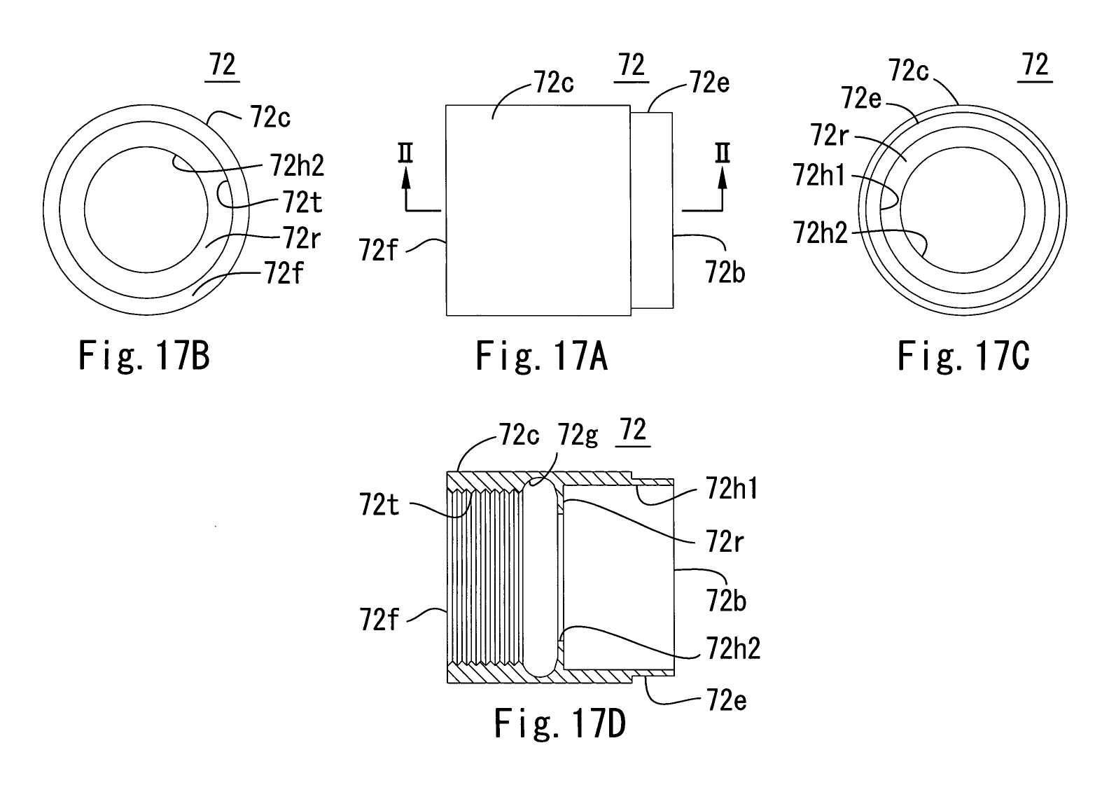

FIGS. 17A-17D show a side view, a front view, a back view and a side cross sectional view at line II-II of FIG. 17A of a second part 72 of a REVERSIBLE air valve connecting portion 70 according to the present invention. Referring to the Figs, numeral 72c designates a cylindrical portion having a round inner radial ring 72r integrally formed therewith along the inner central surface thereof Numeral 72t designates a thread portion formed at one end 72f (hereinafter referred to as the front end 720 of the cylindrical portion 72c and numeral 72g designates a radial groove formed in the inner wall of the cylindrical portion 72c between the inner end of the thread portion 72t and the front side of the ring 72r and is provided for receiving an O ring 155 therein. The cylindrical portion 72c on the other end (hereinafter referred to as the back end 72b) of the ring 72r has a round hole 72h1 the inner surface of which is smooth.

The outer diameter of the rings 71r1 and 71r2 of the first part 71 are slightly smaller than the inner diameter of the hole 72h1 in the back end 72b of the second part 72 so that the rings 71r1 and 71r2 can be inserted into the hole 72h1 up to the point where the ring 71r1 of the first part 71 is adjacent to the back side of the ring portion 72r. The length of the hole 72h in the cylindrical portion 72c is longer than the axial distance between the rings 71r1 and 71r2 of the first part 71, so that the rings can be completely inserted inside the hole 72h in the second part second part 72 and so that the extending ends 72e of the cylindrical portion 72c in the back end 72b of the second part 72 extending past the rings 71r2 and 71r1 can be folded to permanently couple the parts 71 and 72 to each other while allowing them to rotate with respect to each other.

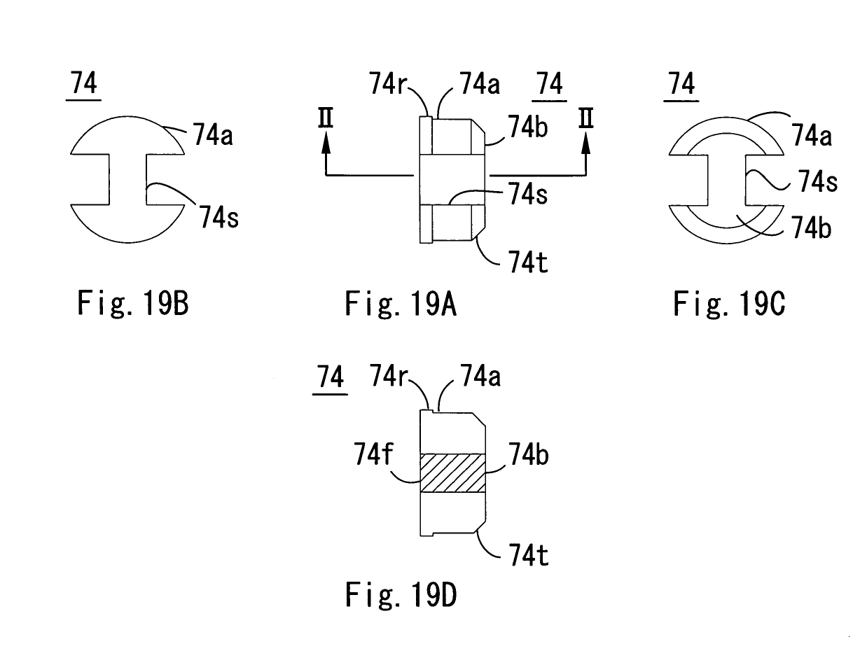

FIGS. 19A-19D show a side view, a front view, a back view and a side cross sectional view at line II-II of FIG. 19A of a fourth part 74 of the REVERSIBLE air valve connecting portion 70 according to the present invention. Referring to the Figs., numeral 74 generally designates a fourth part which comprises a round shaft portion 74a having two axial grooves 74s formed along the outer surface thereof in the axial direction thereof on opposing sides thereof Numeral 74r designates a round outwardly facing radial ring portion which is integrally formed with the shaft 74a along one end 74f thereof (hereinafter referred to as the front end 740. Numeral 74t designates a taper formed on other end 74b (hereinafter referred to as the back end 74b) of the shaft portion 74a and is provided for facilitating the insertion of the shaft portion 74a into the third cylindrical portion 71c of the first part 71. Namely, the extending end of the tapered portion 74t has a smaller diameter than the inner diameter of the third cylindrical portion 71c of the first part 71.

The outer diameter of the shaft 74a of the part 74 is slightly larger than the inner diameter of the hole 71d3 in third cylindrical portion 71c of the first part 71, so that it may be frictionally inserted therein. The ring portion 74r prevents the shaft portion 74a from being inserted therebeond into the cylindrical portion 71c of the first part 71. The outer diameter of the ring portion 74r in the part 74 is smaller than the inner diameter of the hole 72h2 in the ring portion 72r in the second part 72.

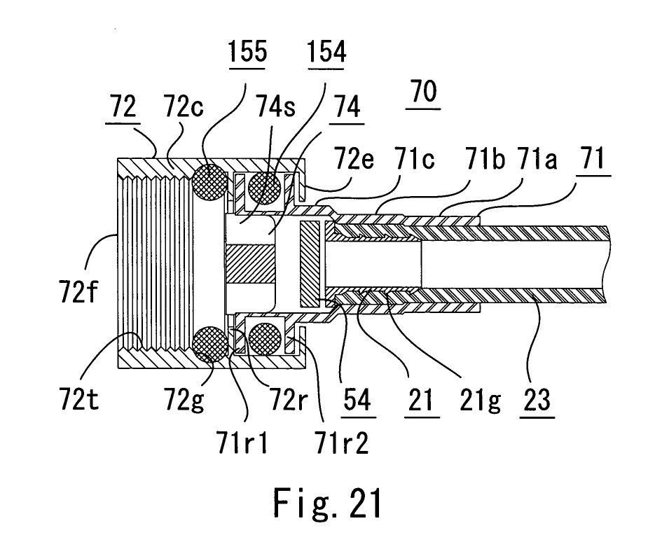

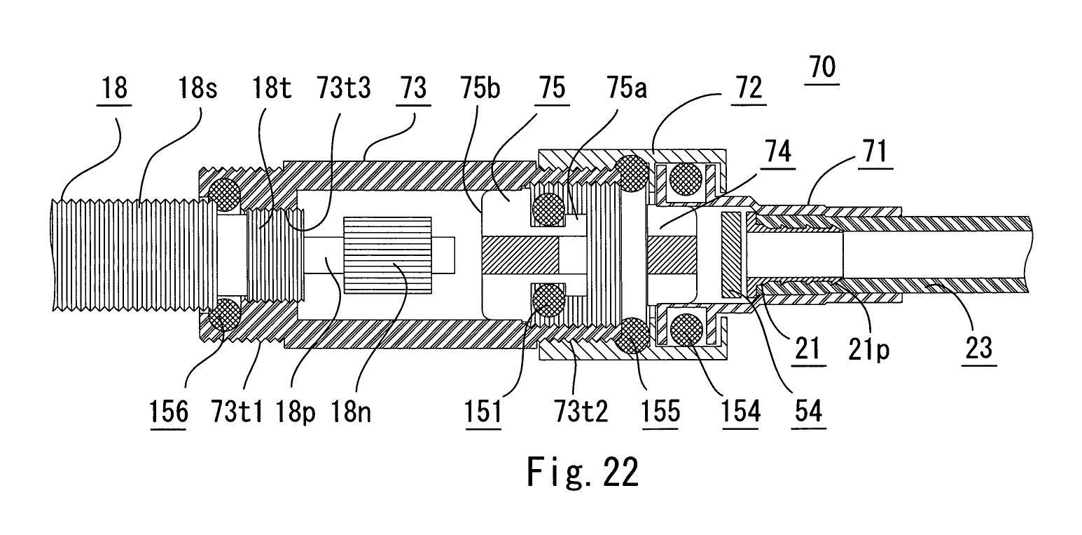

FIG. 21 shows a side cross sectional view of the first, second and fourth parts of the REVERABLE air valve connecting portion 70 in the assemble form.

Referring to FIGS. 21, numeral 154 designates an 0 ring mounted between the rings 71r1 and 71r2 on the cylindrical portion 71c of the first part 71 of the reversible connecting portion 70 and is provided for blocking air from escaping between the first part 71 and the second part 72 when pumping air therethrough.

The distance between the inner walls of the rings 71r1 and 71r2 is slightly greater than the thickness of the O ring 154 and the inner diameter of O ring 154 is slightly larger than the outer diameter of the third cylindrical portion 71c of the first part 71, so that the O ring 154 is free to float around the first part 71, (i.e. almost no friction exist between the O ring 154 and the part 71 when one is rotated with respect to the other). The outer diameter of the O ring 154 is slightly larger than the inner diameter of the hole 72h1 in the second part 72, so that an air tight seal is provided therebetween while the first part 71 can be easily be rotated with respect to the second part 72.

To assemble the parts 71 and 72 together, first one end of the air hose 23 is inserted into the back end 71b of the first part 71 until the hose 23 protrudes out of the front end 71f of the part 71. Next, the nipple 23 is pushed into the extending end of the hose 23 until the ring 21r of the nipple 21 butts up against the extending end of the hose 23. Next, the hose 23 is pulled backwards from the back end 71b of the first part 71 until the ring portion 21r of the nipple 21 is against the inner end of the third cylindrical portion 71c in the first part 71. Namely, the outer diameter of the ring portion 21r of the nipple 21 is larger than the hole 71d2 in the second cylindrical portion 71b of the part 71 and smaller than the hole 71d3 in the third cylindrical portion 71. Accordingly, the hose 23 having the nipple 21 inserted therein can be pulled back through the third cylindrical portion 71c of the first part 71 until the ring portion 21r of the nipple 21 hits the inner wall of the first part 71 between the second and third cylindrical portion 71b, 71c of the first part 71, so that the hose 23 having the sleeve portion 21s of the nipple 21 inserted therein is permanently locked in the second and first cylindrical portion 71b, 71a of the first part 71. Accordingly, the first and second cylindrical portions 71a, 71b, in conjunction with the nipple 21 provide the function of air hose attaching means 100.

Next the diaphragm portion 54 (shown in FIGS. 11A, 11B) is inserted through the front end 72f of the second part 72 until the diaphragm 54 is adjacent to the ring 21r of the nipple 21. Next, the back end 74b of the shaft 74a of the fourth part 74 of the REVERSIBLE air valve connecting portion 70 is inserted into the central hole in the second part 72. Next, the shaft 74a of the fourth part 74 is pressure fitted into the front end 71f of the first part 71 until the ring portion 74r of the fourth part 74 is adjacent to the surface of the front end 71f of the first part 71. Namely, the shaft portion 74a of the part 74 is slightly larger than the hole 71d3 in the third cylindrical portion 71c of the first part, and must be pressure inserted therein using a conventional press machine. When the fourth part 74 is completely inserted in the first part 71, the back end 74b of the fourth part 74 is about 2 mm away from the front end of the ring portion 21r of the nipple 21, and accordingly, the diaphragm 54 can move back and fourth (i.e. The thickness of the diaphragm is 1 mm) to allow air to flow through the parts 71, 72, 74 thus assembled.

Next, the front end 71f of the first part 71 having the O ring 154 mounted thereon between the rings 71r1 and 71r2 is inserted into the hole 72h in the back end 72b of the second part. Next, the extending ends 72e of the second part 72 are folded over the back side of the ring 71r2 using a press machine or using a rolet on a lathe using conventional folding techniques well know in the art.

The thickness of the walls of the extending portion 72e is less than the thickness of the walls of the portion 72c of the part 72, so that the extending portion 72e is easier to bend inwards towards the centre of the part 72.

Next the O ring 155 is inserted into the groove 72g in the second part 72. The thus assembled parts 71, 72, 74 and O rings 154, 155 and the diaphragm 54 will together be called REVERSIBLE air valve support portion means.

Next, the REVERSIBLE air valve mounting means will be described.

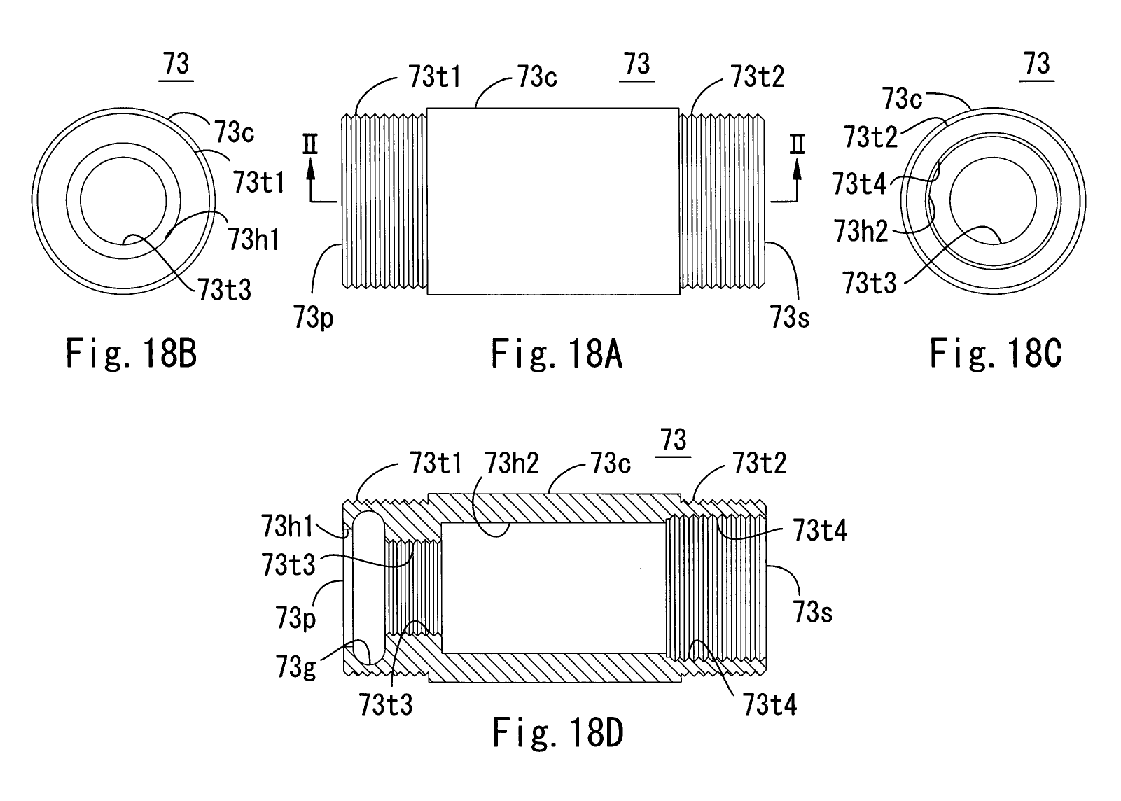

FIGS. 18A-18D show a side view, a front view, a back view and a side cross sectional view at line II-II of FIG. 18A of a third part 73 of the REVERSIBLE air valve connecting portion 70 according to the present invention. Referring to the Figs., numeral 73 generally designates a third part which comprises a cylindrical portion 73c having thread 73t1 and 73t2 formed on the outer surface thereof The thread portion 73t1 extends from one end 73p (hereinafter referred to as the Presta end 73p) of the cylindrical portion 73 partly towards the centre of the cylindrical portion 73c and the thread 73t2 extends from the other end 73s (hereinafter referred to as the Schrader end 73s) of the cylindrical portion 73c partly towards the centre of the cylindrical portion 73c for about 5 mm length.

Numeral 73t3 designates a thread portion (hereinafter referred to as the presta thread 73t3) formed on the inner surface of the cylindrical portion 73c and numeral 73g designates a radial groove formed on the inner surface of the cylindrical portion 73c. The groove 73g is formed about 0.5 mm from the opening of the Presta end 73p of the cylindrical portion 73c and the presta thread portion 73t3 is formed adjacent to the groove 73g. The Presta thread 73t3 is about 5 mm long and extends from the inner side of the groove 73g into the centre of the cylindrical portion 73c.

Numeral 73t4 designates a thread portion (hereafter referred to as Schrader thread portion 73t4) formed on the inner walls of the cylindrical portion 73 along the Schrader end 73s thereof. The Schrader thread portion 73t4 extends from the Schrader end 73s for about 10 mm into the center of the cylindrical portion 73c.

Numeral 73h2 designates a cylindrical hole formed inside the central portion of the cylindrical portion 73c and extends from the inner side of the Presta thread portion 73t3 to the inner side of the Schrader thread portion 73t4. The diameter of the hole 73h2 is larger than the inner diameter of the Presta thread portion 73t3. The diameter of the hole 73h2 is smaller than the inner diameter of the Schrader thread portion 73t4.

The Presta thread portion 73t3 is provided for receiving the thread portion 18t of a Presta type air valve 18 therein and the Schrader thread portion 73t4 is provided for receiving the thread portion 17t of a Schrader type air valve 17 therein.

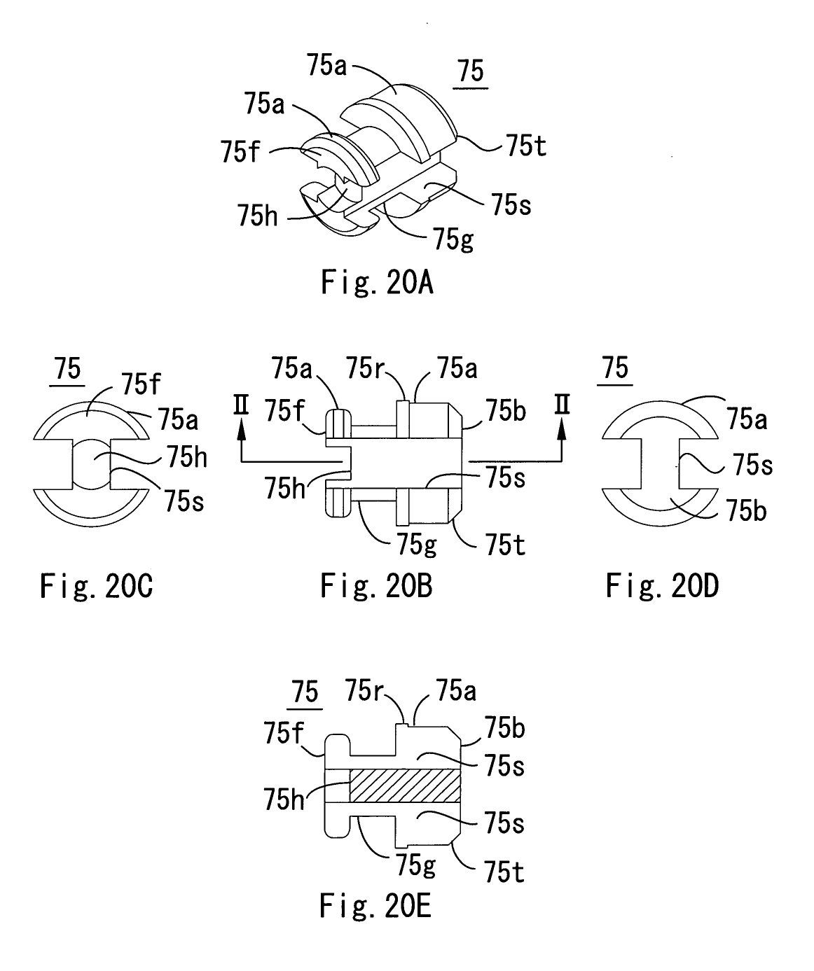

FIGS. 20A-20E show a perspective view, a side view, a front view, a back view and a side cross sectional view at line II-II of FIG. 20B of a fifth part 75 of the REVERSIBLE air valve connecting portion 70 according to the present invention. Referring to the Figs., the fifth part 75 is substantially the same shape as the third part 53 of the American Schrader type valve connecting portion 50.

The fifth part 75 comprises a round shaft 75a having two axial slots 75s formed therein in the axial direction thereof. The slots 75s extend from the front end 75f to the back end 75b of the shaft 75a.

The shaft 75a further has a radial groove 75g formed along a central portion thereof and in the radial direction thereof for mounting a conventional rubber O ring 151 therein.

Numeral 75r designates an outwardly extending radial ring integrally formed with the shaft 75a along the outer surface thereof and on one side (hereinafter referred to as the back end 75b) of the radial groove 75g.

The shaft 75a on the back end 75b of the radial groove 75g has an outer diameter which is slightly larger than the the diameter of the hole 73h2 in the third part 73 of the REVERSIBLE air valve connecting portion 70, so that it may be frictionally inserted therein using a conventional press machine (not show).

The shaft 75a and the ring 75r on the back end 75b of the radial groove 75g has an outer diameter which is smaller than the the diameter of the Schrader thread 73t4 in the third part 73 of the REVERSIBLE air valve connecting portion 70, so that it fits therein.

The back end 75b of the shaft 75 is tapered 75t, so that it may facilitate the pressure insertion of the shaft 75a into the hole 73h2 in the third cylindrical portion 73c of the third part 73.

The shaft 75a on the front end 75f of the radial groove 75g has an outer diameter which is smaller than the hole inside a Schrader air valve 17, so that it can slide thereinto to press on the air release pin 17p inside the Schrader air valve 17.

The front end 75f of the shaft 75a has a central round hole 75h formed therein extending backwards from the centre of the front end 75f to where the groove 75g is formed. This hole 75h is provided for allowing the activation pin 17p inside the Schrader air valve 17 to fit therein, so that the activation pin 17p is only pressed when the extending end of the Schrader air valve 17 presses against the O ring 151 mounted in the groove 75g, thereby ensuring that no air escapes prematurely when mounting the REVERSIBLE air connecting portion 70 on a Schrader air valve 17.

To assemble the fifth part 75 in the third part 73, first an O ring 151 is mounted in the groove 75g. Next the back end 75b of the shaft 75a of the fifth part 75 is inserted into the third part 73 from the Schrader end 73s thereof and then a press machine (not shown) presses the back end 75b of the shaft 75a to frictionally slide into the hole 73h in the third part 73. The ring portion 75r ensures that the part 75 is pressed exactly the same distance into the hole 73h every time. Namely, the ring portion 75r is larger than the hole 73h and stops the part 75 from being pressed into the hole 73h beyond the ring 75r.

One end of the hose 23 can be coupled to the air pump connecting portion 40 or 400 and the other end of the hose 23 can be coupled to the REVERSIBLE air valve connecting portion 70, thereby providing an air pump facilitator utilizing the REVERSIBLE air valve connecting portion 70 of the present invention.

To use the facilitator with the REVERSIBLE air valve connecting portion 70 to pump up a tire having a Presta type air valve 18, the thread 73t2 at the Schrader end 73s of the third part 73 is screwed into the thread 72t of the second part 72 until the front end 73s of the third part 73 presses against the O ring 155 to form a hermetic seal therebetween. Next, the REVERSIBLE air valve 70 is manually turned clockwise to cause the thread 18t of the Presta valve 18 to screw into the thread 73t3 in the third part 73 of the REVERSIBLE air valve 70 until the extending end of the shaft portion 18s of the Presta valve 18 presses against the O ring 156 in the groove 73g to create a hermetic seal therebetween. At this time, the third part 73 and the second part 72 are free to rotate clockwise or counter clockwise with respect to the first part 71 while all parts are hermetically sealed with respect to each other while allowing pressurized air to flow therethrough into the tire. When no air is being pumped through the REVERSIBLE air valve 70, the diaphragm 54 prevents pressurized air from flowing backwards through the REVERSIBLE air valve 70.

The REVERSIBLE air valve connecting portion 70 can also be used to pump up an air tire having a British type Dunlop air valve, since the thread size and the thread pitch of the Dunlop and Presta air valves is substantially the same.

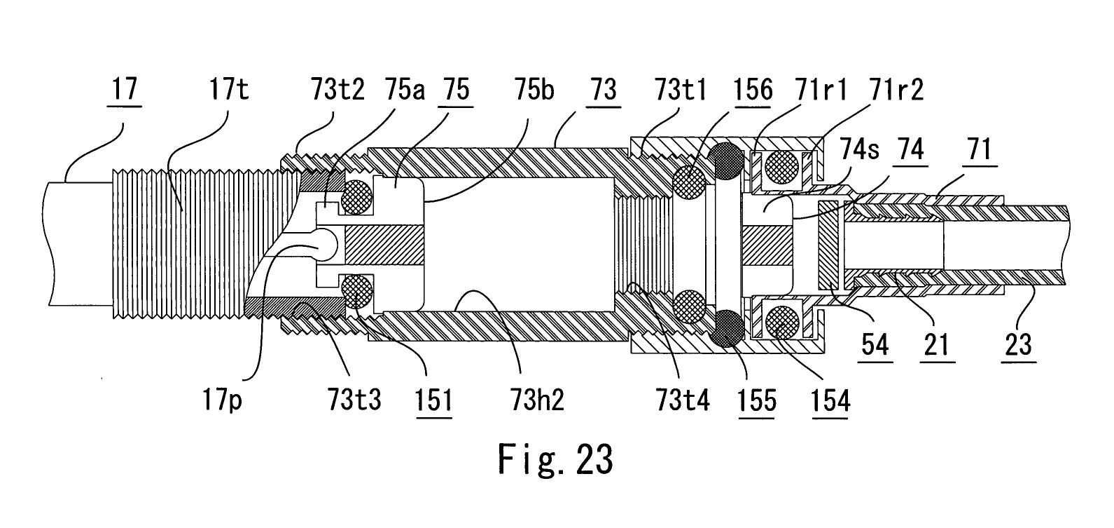

To use the facilitator with the REVERSIBLE air valve connecting portion 70 of the present invention, to pump up a tire having a Schrader type air valve 17, as shown in FIG. 23, the thread 73t1 at the Presta end 73p of the third part 73 is screwed into the thread 72t of the second part 72 until the front end 73p of the third part 73 presses against the O ring 155 to form a hermetic seal therebetween. Next, the REVERSIBLE air valve 70 is manually turned clockwise to cause the thread 17t of the Schrader air valve 17 to screw into the thread 73t3 in the third part 73 of the REVERSIBLE air valve 70 until the extending end of the Schrader valve 17 presses against the O ring 151 in the groove 75g of the fifth part 75 to create a hermetic seal therebetween. At this time, the pin 17p inside the Schrader valve 17 is pressed by the front portion 75f of the fifth part 75 to allow air to flow into and out of the Schrader valve 17. However, the diaphragm 54 inside the REVERSIBLE air valve 70 prevents air from flowing out of the Schrader air valve 17 (i.e. The diaphragm 54 provides the function of a one way air valve).

The male thread portions 73t1 and 73t2 on the outer surface of the third part 73 have the same size and pitch thread and fit perfectly into the female thread portion 72t in the second part 72. Furthermore, the length of the thread portions 73t1 and 73t2 is just long enough to allow the Schrader end 73s and the Presta end 73p to be screwed into the second part 72 far enough to squeeze the O ring 155 just enough to create an air tight seal therebetween but not too much to damage the O ring 155.

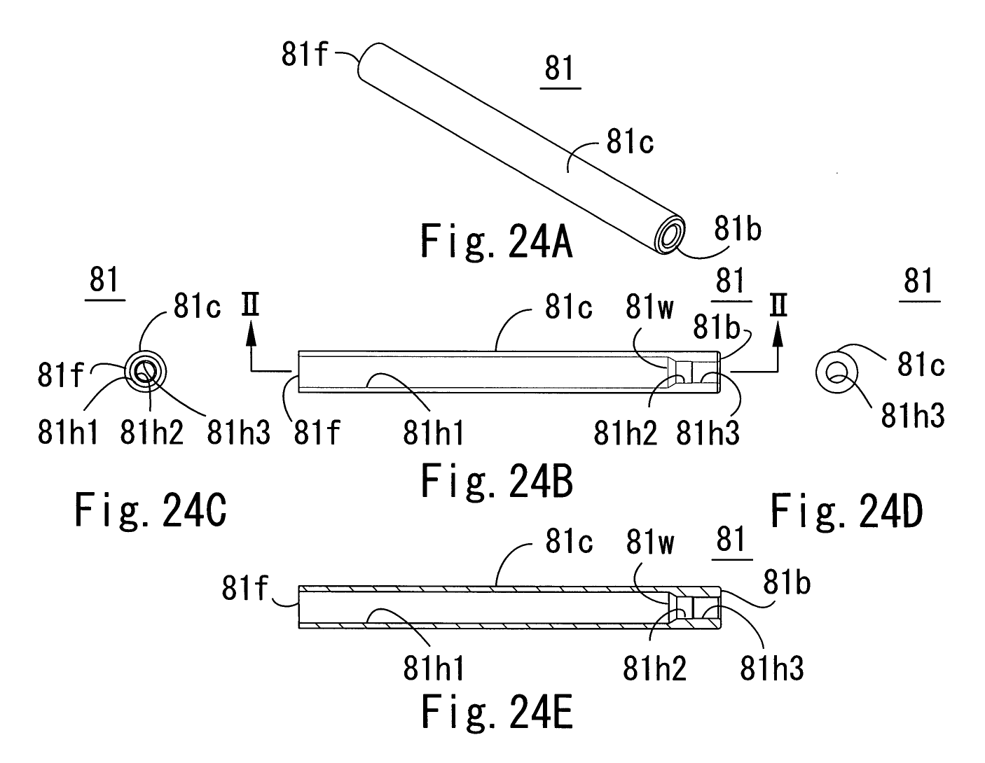

FIGS. 24A-24E show a perspective view, a side view, a front view, a back view and a side cross sectional view at line II-II of FIG. 24B of an outer transparent cylindrical portion 81 of the INLINE air pressure gauge according to the present invention. The cylindrical portion 81 is formed from transparent plastic such as acryl or polycarbonate using conventional injection molding techniques.

Referring to the FIGS. 24A-24D, the outer cylindrical portion 81c is cylindrical in shape and has three coaxially formed cylindrical holes 81h1, 81h2, 81h3 formed through the center thereof.

The first cylindrical hole 81h1 is larger than the second cylindrical hole 81h2 and the second cylindrical hole is larger than the third cylindrical hole 81h3. The first cylindrical hole 81h1 extends from the front end 81f of the cylindrical portion 81 to the front end of the second cylindrical hole 81h2. The third cylindrical hole 81h3 extends from the back end 81b of the cylindrical portion 81c to the back end of the second cylindrical hole 81h2.

The first hole 81h1 extends substantially through most of the cylindrical portion 81c.

The hole 81h3 has the same diameter as the outer diameter of the hose 23. The hole 81h2 is slightly larger than the outer diameter of the air hose 23 but smaller than the diameter of the air hose 23 when the sleeve portion 21s of the nipple 21 is inserted thereinto.

The outer diameter of the sleeve portion 21s and the protrusions 21p of the nipple 21 have a smaller outer diameter than the inner diameters of the holes 81h2 and 81h1 in the outer cylindrical portion 81. The outer diameter of the ring portion 21r of the nipple 21 is larger than the hole 81h2 and smaller than the hole 81h1 in the cylindrical portion 81.

To mount the hose 23 inside the outer cylindrical portion 81, first one end of the hose 23 is inserted through the hole 81h3 in the back end 81b of the outer cylindrical portion 81 until the end of the hose 23 protrudes beyond the front end 81f of the outer cylindrical portion 81. Next, the sleeve portion 21s of the nipple 21 is inserted into the extending end of the hose 23 until the ring portion 21r of the nipple 21 butts up against the extending end of the hose 23. Next, the hose 23 is pulled back from the back end 81b of the outer cylindrical portion 81 until the end of the hose 23 is pulled into the hole 81h2 and the ring portion 21r of the nipple 21 butts up against the inner wall 81w surrounding the hole 81h2, thereby permanently locking the hose 23 in the holes 81h2, 81h3 in the outer cylindrical transparent portion 81.

The holes 81h2 and 81h3 in the back end of the outer cylindrical portion 81 together with the nipple 21 provide the function of air hose attaching means 100, similar to the air hose attaching means 100 in the air pump connecting portions 40 and air valve connecting portion 50, 60 and 70.

Preferably, the cylindrical portion 81c is 60-100 mm long, the outer diameter of the cylindrical portion 81c is 7-10 mm, the inner diameter of the hole 81h1 is 5-8 mm.

Preferably, the diameters of the holes 81h2, 81h3 is 4.2 mm and 4.0 mm, respectively. The outer and inner diameters (i.e. OD, ID) of the hose 23 are 4.0 and 2.5 mm, respectively. The length of the holes 81h2 and 81h3 are 5 mm each. The length of the nipple 21 used to connect the hose 23 to the outer cylindrical portion 81 is 4 mm. The outer diameter of the ring portion 21r of the nipple 21 is 4.5 mm, the outer diameter of the shaft portion 21s and protrusions 21p of the nipple 21 are 3.0 mm and 3.2 mm, respectively. The diameter of the hole 21h inside the nipple 21 is 2.5 mm.

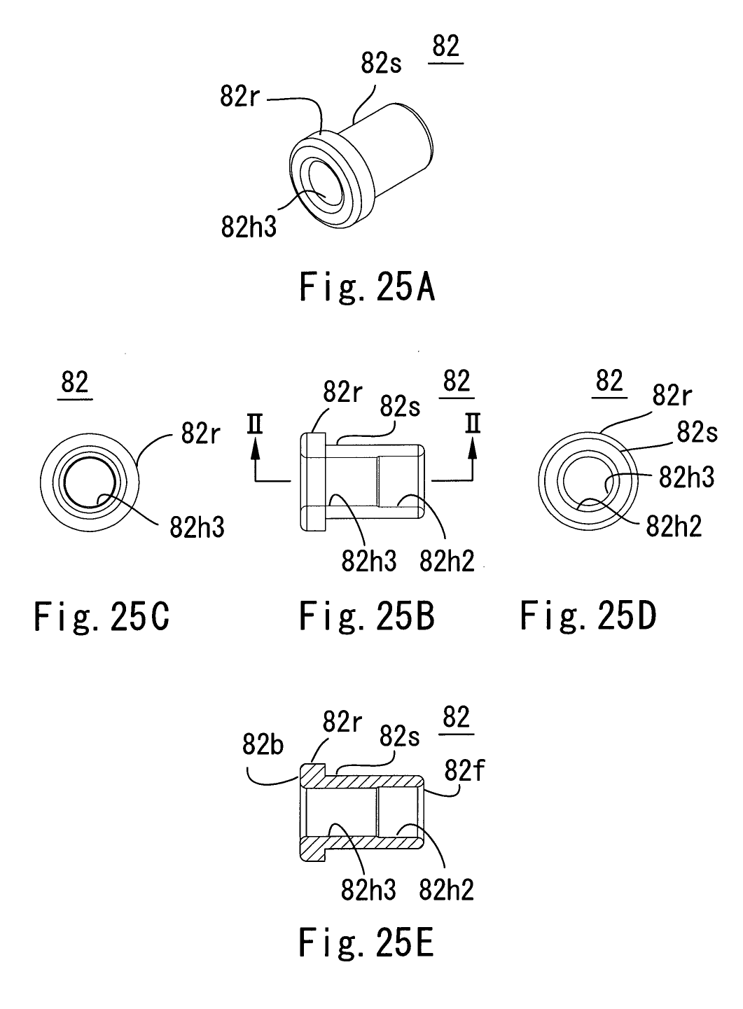

FIGS. 25A-25E show a perspective view, a side view, a front view, a back view and a side cross sectional view at line II-II of FIG. 25B of a cap portion 82 of the INLINE air pressure gauge 80 according to the present invention. Referring to the Figs., numeral 82s designates a round sleeve portion having a outwardly facing radial ring portion 82r integrally formed therewith along one end 82b thereof (hereinafter referred to as the back end 82b). The outer diameter of the sleeve portion 81s of the cap portion 82 is the same as the inner diameter of the hole 81h1 in the outer cylindrical portion 81. The outer diameter of the ring portion 82r of the cap portion 82 is the same as the outer diameter of the cylindrical portion 81.

Numerals 82h2 and 82h3 designate coaxial cylindrical holes formed through the center of the cylindrical sleeve 82. The diameters of the holes 82h2 and 82h3 in the cap portion 82 is the same as the diameters of the holes 81h2 and 81h3 in the outer cylindrical portion 81, respectively, and, in conjunction with the nipple 21, surve as the air hose attaching means 100.

To assemble the air hose 23 in the cap portion 82, first one end of the air hose 23 is pushed into the holes 82h2 and 82h3 until the end of the hose stick out of the front end 82f of the sleeve portion 82s. Next, the sleeve portion 21s of the nipple 21 is inserted into the extending end of the hose 23 until the ring portion 21r of the nipple 21 butts up against the extending end of the hose 23. Next, the hose 23 is pulled back from the back end 82b of the cap portion 82 until the ring portion 21r of the nipple 21 butts up against front end 82f of the sleeve portion 82s, thereby permanantly locking the hose 23 in the holes 82h2, 82h3 in the cap portion 82.

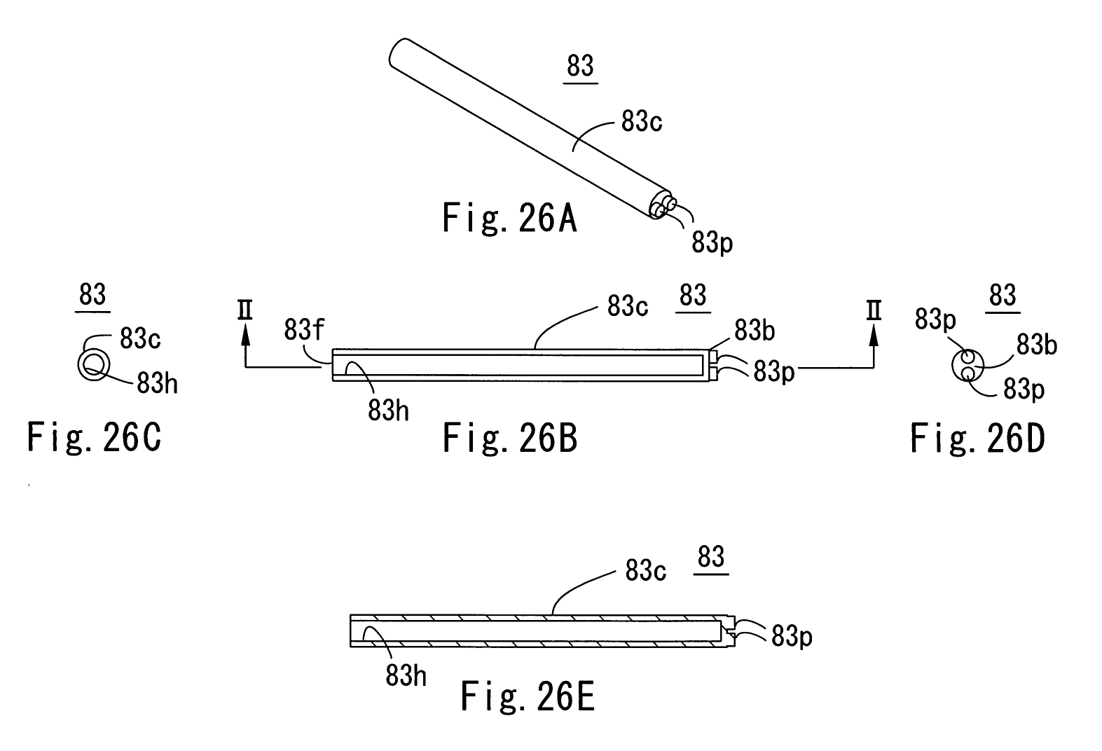

FIGS. 26A-26E show a perspective view, a side view, a front view, a back view and a side cross sectional view at line II-II of FIG. 26B of a transparent inner cylindrical portion 83 of the INLINE pressure gauge 80 according to the present invention. Referring to the Figs., numeral 83c designates a cylindrical portion having one open end 83f (hereinafter referred to as the front end 83f) and the other end 83b (hereinafter referred to as the back end 83b) of which is closed.

The outer diameter of the inner cylindrical portion 83 is smaller than the inner diameter of the hole 81h1 in the outer cylindrical portion 81, so that the inner cylindrical portion 83 can be inserted into the outer cylindrical portion 81 as well as allow air to flow therebetween.

Numeral 83p designates a pair of round protrusions formed on the extending end of the closed end 83b of the inner cylindrical portion 83. The protrusions 83p are provided for making sure that the closed end 83b of the inner cylindrical portion does not butt up against the inner end of the back end 81b of the outer cylindrical portion 81, thereby ensuring that air can flow therebetween.

The length of the inner cylindrical portion 83 is shorter than the length of the hole 83h1 inside the outer cylindrical portion 81 when the sleeve portion 82s of the cap portion 82 is inserted into the front end 81f of the outer cylindrical portion 81.

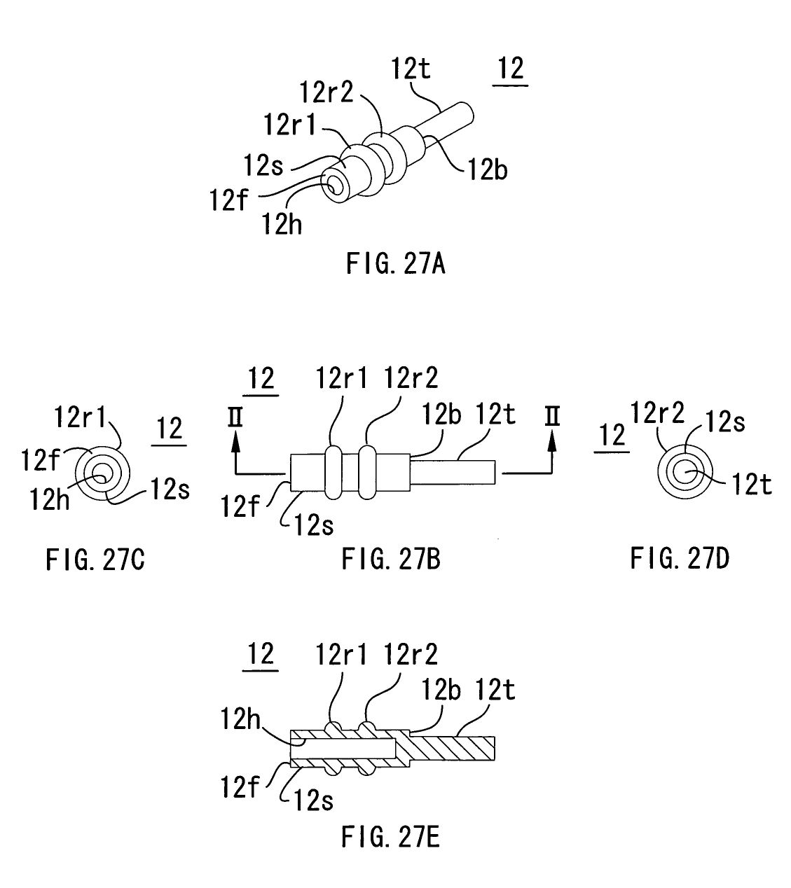

FIGS. 27A-27E show a perspective view, a side view, a front view a back view and a side cross sectional view at line II-II in FIG. 27B of a piston 12 of the INLINE air pressure gauge 80 according to the present invention.

Referring to FIGS. 27A-27E numeral 12 generally designates a piston formed of a resilient type material such as rubber or silicone. Numeral 12s designates a round shaft portion having a cylindrical shaped opening 12h formed therein extending from the front end 12f of the shaft portion 12s partially therethrough to the back end 12b thereof. The back end 12b of the piston 12 is closed providing a hermetic seal. Numeral 12r1 and 12r2 designate a pair of round outwardly facing radial rings integrally formed with the shaft portion 12s along the outer surface thereof.

The shaft 12s has an outer diameter which is smaller than the diameter of the hole 83h in the inner cylindrical portion 83. The outer diameters of the rings 12r is the same as or slightly larger than the inner diameter of the cylindrical hole 83h of the inner cylindrical portion 83, so that the rings 12r of the piston 12 frictionally slide inside the cylindrical portion 83 while not allowing air to pass between the rings 12r1 and 12r2 of the piston 12 and the inner walls 83h of the inner cylindrical portion 83. Numeral 12t designates a second round shaft portion (hereinafter referred to as a tail portion 12t) integrally formed with the back end 12b of the shaft portion 12a. The tail portion 12t has an outer diameter which is smaller than the outer diameter of the shaft portion 12a, so that one end of a spring 20 can be mounted around the tail portion 12t, while not touching the inner walls of the inner cylindrical portion 83, as well as allow the end of the spring 20 mounted on the tail portion 12t to push against the back end 12b of the shaft 12s of the piston 12. The spring 20 has an outer diameter which is smaller than the inner diameter of the hole 83h of the inner cylindrical portion 83 even when the spring 20 is in the compressed state during high air pressure measurements.

Accordingly, when the piston 12 is inserted into the inner cylindrical portion 83, only the rings 12r1, 12r2 come into contact with the inner walls 83h of the inner cylindrical portion 83. The tail portion 12t should be facing inwards towards the closed end 83b of the inner cylindrical portion 83. The tail portion 12t is only necessary in the case where a spring 20 is included inside the cylindrical portion 83. Otherwise, the tail portion 12t is not necessary.

Since one end of the inner cylindrical portion 83 is closed, and since the air pressure between the inner end of the piston 12 and the closed end 83b of the inner cylindrical portion 83 is at 1 atmosphere (i.e. the piston 11 is inserted into the open end of the inner cylindrical portion 83 at 1 atmosphere during assembly of INLINE air pressure gauge 80), as the pressure goes up at the open end 83f of the inner cylindrical portion 83, the piston 12 slides into the inner cylindrical portion 83 to a point where the pressure at both ends of the piston 12 are the same. Namely, as the piston gets pushed towards the closed end 83b of the inner cylindrical portion 83, due to the air pressure at the open end 83f of the inner cylindrical portion 83 increasing, the piston 12 slides into the inner cylindrical portion 83 compressing the air between the inner end 12b of the piston 12 and the closed end 83b of the inner cylindrical portion 83 to a point where the pressure at both ends of the piston 12 is the same (i.e. according to the well known law of physics p1v1=p2v2). Since air has a given coefficient of compression, a conventional transparent film made of polypropylene, etc., having numerals printed thereon representative of pressure present inside the INLINE pressure gauge (i.e. 10, 20 30 psi) can be glued to the outside of the inner cylindrical portion 83, whereby the pressure inside a tire to which the facilitator 50, 60 or 70 having an INLINE pressure gauge mounted along a central portion of the hose 23 is mounted on can be viewed at a glance (i.e. the position of the piston 12 inside the transparent inner cylindrical portion 83 lining up with a number representative of air pressure number marked on the transparent film mounted on the outer surface of the inner cylindrical portion 83).

In another embodiment, the numerals such as 10 psi, 20 psi are also printed in yellow, the numerals 30 psi, 40 psi and 50 psi are printed in green and the numerals 60 psi, 70 psi, etc., are printed in red on the transparent film. Alternatively, the film is painted with semi transparent colours yellow, green and red and the numerals 10-80 psi in dark black, the yellow colour indicating not enough air, the green painted area indicating just the right amount of air and the red painted numerals/area indicating to much air pressure, respectively.

Most mountain type bicycles require about 30-60 psi. Accordingly, the film portion indicating those pressures should be painted in green on the inner cylindrical portion 83 of the INLINE pressure indicator 80. However, in the case of racing bikes, the 60 psi-90 psi should be painted in green. Accordingly, by simply applying differently painted films to the inner cylindrical portion 83, any person can easily discern at a glance if they have enough air in their tire by just looking at the colour at which the piston 12 is resting at. Furthermore, the numbers 10 psi, 20 psi, etc., can be directly embossed on the outer surface of the inner cylindrical portion 83, thereby eliminating the need for a film.

The two rings 12a, 12b provide for minimal sliding friction between the outer surface of the rings 12a, 12b and the inner walls 83h of the inner cylindrical portion 83, as well as ensure that the piston 12 is aligned co-axially with the inner walls 83h of the inner cylindrical portion 83, thereby ensuring for smooth sliding of the piston 12 with respect to the inner walls 83h of the inner cylindrical portion 83 as the air pressure changes therein.

Furthermore the hole 12f inside the piston 12 allows the walls of the piston 12 around the hole 12f to expand outwardly when the pressure suddenly increases due to the attachment of the facilitator 50, 60 or 70 having the INLINE pressure gauge 80 mounted along a central portion of the air hose 23 to a bicycle air tire, thereby causing the rings 12a, 12b to press harder against the inner walls 83h of the inner cylindrical portion 83, to prevent the high pressure air from going around the rings 12a, 12b.

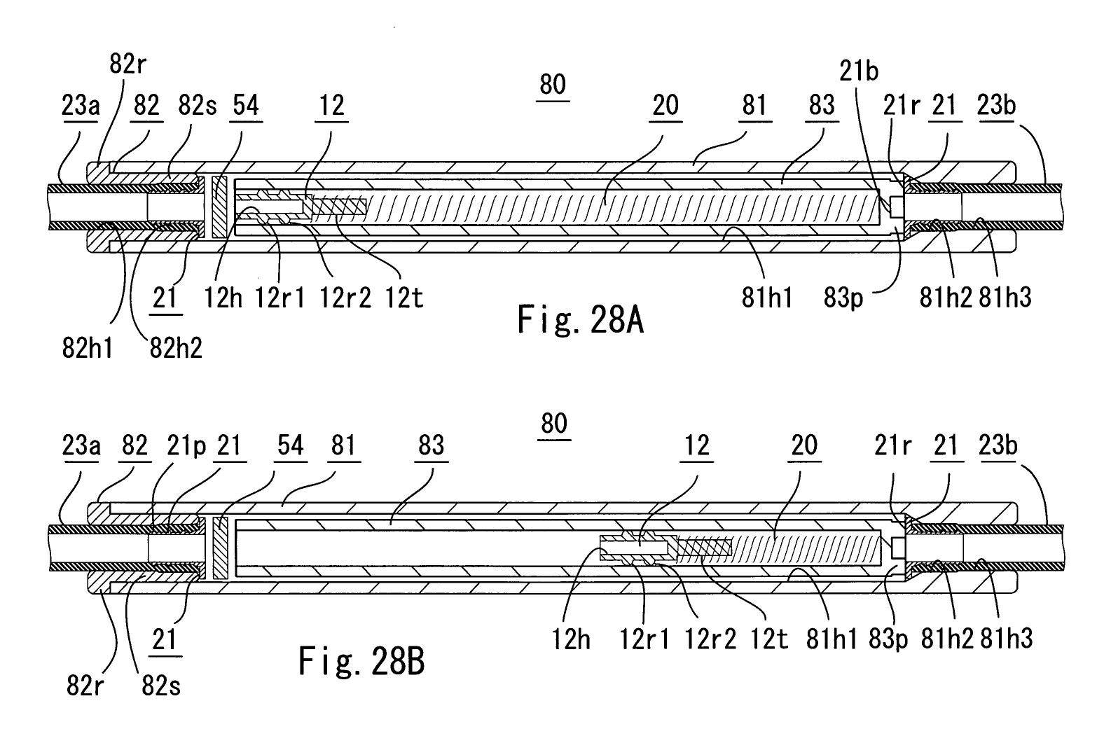

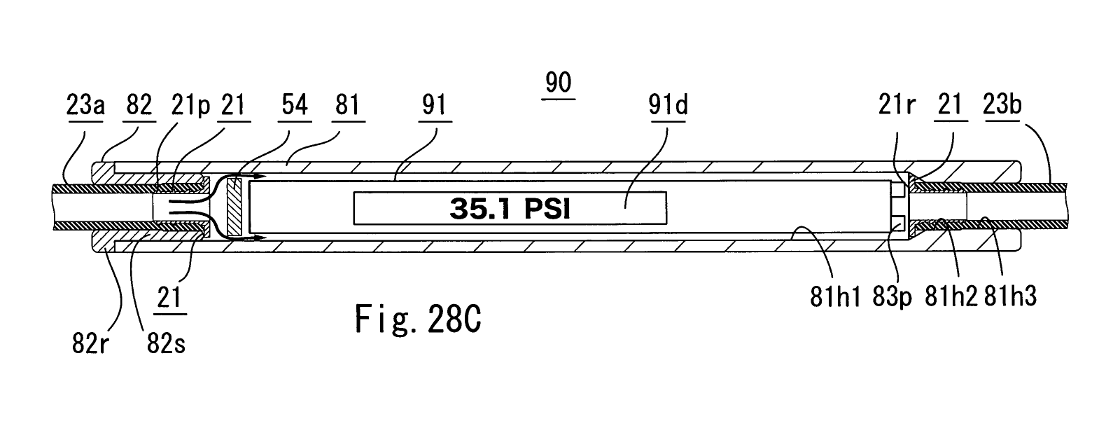

When the pressure at the open end of the inner cylindrical portion 83 returns to 1 atmosphere, the piston 12 returns to its original position, namely, to the open end 83f of the inner cylindrical portion 83, as shown in FIG. 28A.

It should be noted that the piston 12 can be inserted into the inner cylindrical portion 83 in a controlled environment such as a transparent box full of argon, freon, or any other non volatile gas which is heavier than air. The nipple 12 can be inserted into the inner cylindrical portion 83 by using a pair of rubber gloves installed in the side of the transparent box. Namely, hundreds of inner cylindrical portion 83 and hundreds of nipples 12 can be housed in a transparent box. Argon or Freon gas can be pumped into the hermetically sealed box and then using the gloves hermetically mounted in round holes in the side of the box a person can physically insert the pistons 12 into the argon or freon filled inner cylindrical portions 13. Then, the box can be opened and the inner cylindrical portions 83 having the nipples 12 inserted therein can be taken out of the box.

It should be noted that a lubricant such as made by Toray silicone should be applied to the ring 12a, 12b, and the inner walls 83h of the inner cylindrical portion 83, so that the piston slides smoothly inside the inner cylindrical portion 83. Alternatively, the inner walls of the inner cylindrical portion 83 and/or the piston 12, may be coated with a Teflon like material to ensure a slippery surface for the piston 12 to slide in.

At the same time air can flow inside the outer cylindrical portion 81, around the inner cylindrical portion 83 and flow from the air pump connecting portion 40 to the air valve connecting portion 50, 60 or 70.

The diaphragm 54 is 1 mm thick and slightly smaller in diameter than the inner diameter of the outer cylindrical portion 81. Furthermore, there is a 2 mm space between the front end 82f of the cap portion 82 and the front end of the inner cylindrical portion 81, so that the diaphragm 54 can move back and fourth to allow air to flow in only one direction, namely from the air pump connecting portion 40 to the air valve connecting portion 50 or 60.

FIG. 28 shows a side cross sectional view of an INLINE air pressure gauge 80 according to the present invention in the assembled state.

To assemble the INLINE air pressure gauge 80, first a first air hose 23b is passed through the hole 81h3, 81h2 and 81h1 in the outer cylindrical portion 81. Next, the end of the hose 23b sticking out of the open front end 81f of the outer cylindrical portion 81 has the sleeve portion 21s of the nipple 21 inserted therein until the ring portion 21r butts up against the extending end of the air hose portion 23b. Next, the hose 23 is pulled back from the back end 81b of the outer cylindrical portion 81 until the ring portion 21r butts up against the wall 81w at the front side of the hole 81h2, and the end of the hose 23 having the shaft portion 21s inserted therein is locked in the holes 81h2, 81h3 of the outer cylindrical portion 81, forming a hermetic seal therebetween.

Next, one end of the hose 23a is inserted through the holes 82h3, 82h2 in the cap portion 82 until the end of the hose is completely out of the cap portion 82. Next, the shaft portion 21s of the nipple 21 is inserted into the extending end of the hose 23a until the ring portion 21r of the nipple 21 butts up against the extending end of the hose 23a. Next, the hose 23a is pulled back through the cap portion 82 until the ring portion 21r of the nipple 21 is adjacent to the front end 82f of the cap portion 82 and the end of the hose 23a is locked in the holes 82h2, 82h3 in the cap portion 82.

Next, a spring 20 is inserted inside the inner cylindrical portion 83. The length of the spring 20 is about 5 mm shorter than the length of the hole 83h inside the inner cylindrical portion 83, so that sufficient room is provided for inserting the piston 12 inside the front end 83f of the inner cylindrical portion 83.

The spring constant k should be chosen according to the pressures most desired to be measured by the INLINE pressure gauge 80. Specifically, the higher the air pressure desired to be measured, the stiffer the spring should be (i.e. Higher spring constant, k). Accordingly, for mountain bikes requiring pressures of between 30-60 psi, a lower spring constant spring would be chosen and for racing bikes having thin tires requiring pressures between 60-120 psi a higher spring constant spring would be chosen.

Next, the piston 12 is dipped in a lubricant. Next, the thus lubricated piston 12 is inserted into the open front end 83f of the inner cylindrical portion 83 with the tail end facing the back closed end 83b of the inner cylindrical portion 83. At this time, the tail portion 12t should be inside the front portion of the spring 20.

Next, the inner cylindrical portion 83 is inserted into the outer cylindrical portion 81 until the back end 83b of the inner cylindrical portion 83 is next to the back end 81b of the outer cylindrical portion 81.

Next, an adhesive material is applied to the outer surface of the sleeve portion 82s of the cap portion 82. Next, the front end of the sleeve portion 82s having the adhesive on the outer surface thereof is inserted into the front end 81f of the outer cylindrical portion 81 until the ring portion 82r of the cap portion 82 butts up against the front end of the outer cylindrical portion 81. This completes the assembly of the INLINE air pressure gauge 80.

Next, the air pump connecting portion 40 is mounted on the other end of the first air hose portion 23a, as described above. Next, an air valve connecting portion 50, 60 or 70 is mounted on the other end of the second air hose portion 23b in the manner described above. This completes the assembly of the facilitator 45, 46 or 47.

The INLINE air pressure gauge can be mounted on any conventional air pump hose presently on the market by simply cutting the conventional air hose attached to any conventional air pump at any point along the hose that the user want to install the INLINE air pressure gauge, then assembling the INLINE air pressure gauge using the same method as described above.

FIG. 28C shows a side cross sectional view of a digital INLINE air pressure gauge 90 according to the present invention. The digital INLINE pressure gauge 90 is similar to the INLINE pressure gauge 80 and only the differences therebetween will be described herebelow.

Numeral 91 designates a cylindrical digital air pressure gauge inserted inside the outer cylindrical portion 81. The cylindrical digital air pressure gauge 91 has the same shape and same physical dimensions as the inner cylindrical portion 83. Namely, when assembling the INLINE air pressure gauge 90, instead of inserting the inner cylindrical portion 81 and the piston 12, the digital air pressure gauge 91 is inserted into the outer cylindrical portion 81.

Numeral 91d designates a digital display which displays the air pressure inside the outer cylindrical portion 81. For example, the display shows a pressure of 35.1 psi.

The electronic and mechanical parts needed to construct the digital pressure gauge 91 are well know in the art of air pressure measuring devices.

U.S. Pat. No. 5,531,109 titled “indicator of air pressure based on capacitive coupling” discloses one such device the subject matter of which is incorporated herewith.

U.S. Pat. No. 5,606,123 titled “tire pressure monitoring device . . . ” discloses one more device the subject matter of which is incorporated herewith.

An air pressure indicating device by the name of TIREMINDER available for sale on the market incorporates all the parts required for the digital air pressure gauge 91 of the present invention with the exception of the shape not being round. To change the shape of the product made by TIREMINDER from its present shape to a cylindrical shape is very simple to do for anyone familiar with the art of injection molding techniques.

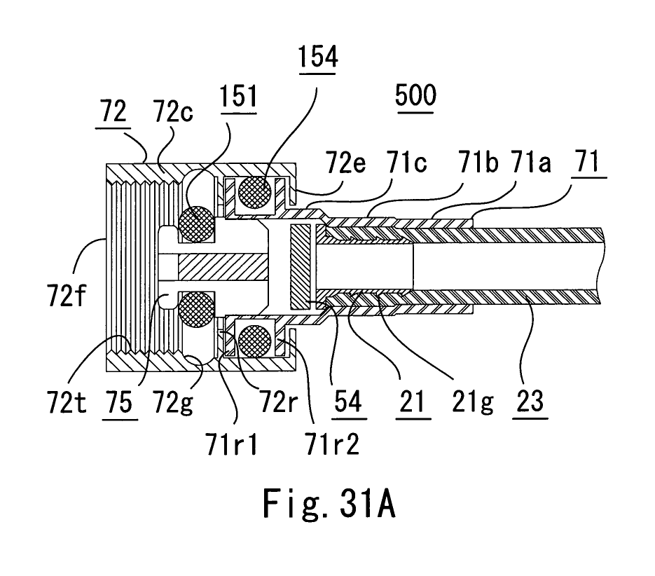

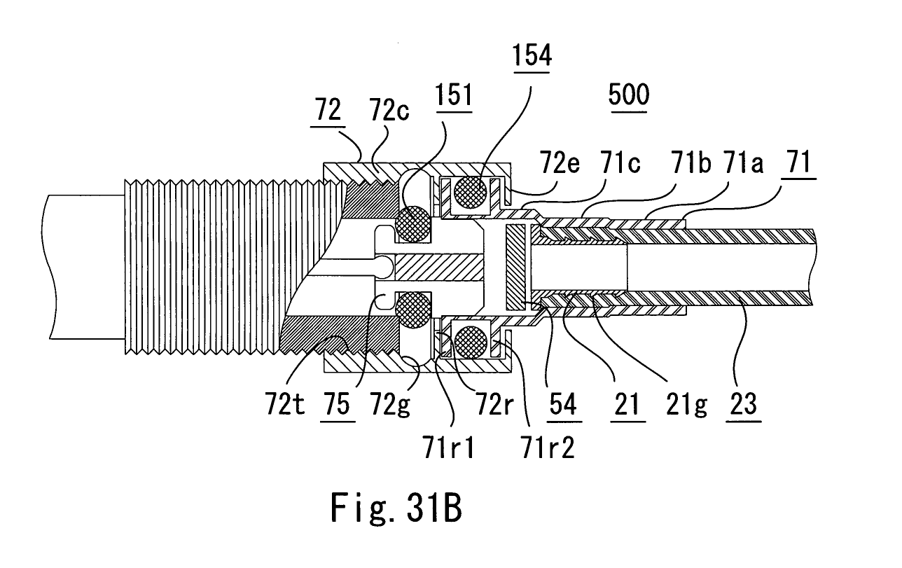

FIG. 31A shows a side cross sectional view of a Schrader air valve connecting portion 500 according to another embodiment of the present invention.

FIG. 31B shows a side cross sectional view of a Schrader air valve connecting portion 500 of FIG. 31A having a Schrader air valve 17 mounted therein.

Referring to FIGS. 31A-31B, numeral 500 generally designates a Schrader air valve connecting portion. Similar parts will be designated by the same numbers or symbols used in the other embodiments of the present invention.

Specifically the parts 71, 72, 75, 74, diaphragm 54 and O rings 151, and 154 are used for the embodiment of the Schrader valve 500.

To assemble the Schrader air valve connector 500, first the O ring 154 is mounted on the cylindrical portion 71 between the rings 71r1 and 71r2. Next, the rings 71r1, 71r2 are inserted into the hole 72h1 in the back end of the part 72. Next, the extending ends 72e are folded over to lock the parts 71 and 72 together while allowing the part 71 to swivel respect to the part 72. Next, the diaphragm 54 is inserted into the third cylindrical portion 71c of the part 71. Next, the O ring 151 is mounted in the groove 75g in the part 75. Next, the back end 75b of the part 75 is frictionally inserted into the front end 71f of the cylindrical portion 71c of the part 71.

The dimensions of the thread 72t in the part 72 must be adjusted to be the same as the thread 17t of the Schrader air valve 17.

It should be noted that the present invention is not intended to be limited to the embodiments disclosed and many variations can be made without departing from the scope and spirit of the present invention.

What is claimed is:

1. A nipple for joining a conventional hose to a conventional part which comprises:
a cylindrical sleeve portion having a hole through the centre thereof;
an outwardly facing ring portion integrally formed with said sleeve portion along one end thereof; and
at least one radial cone shaped protrusion integrally formed with said sleeve portion along the outer surface thereof

2. A nipple as recited in claim 1, wherein:
the outer diameter of said sleeve portion is larger than the diameter of the hole in said hose,
the outer diameter of said sleeve portion and said protrusion is smaller than the diameter of a hole in said part,
the outer diameter of said ring portion is larger than the diameter of said hole is said part,
the outer diameter of said hose is the same as or smaller than the diameter of said hole in said part,
the outer diameter of said sleeve portion and said protrusions are bigger than the hole in said hose,
so that when said sleeve portion of said nipple is inserted into one end of said hose and said hose is pulled through said hole in said part, said nipple locks said hose in said part.

3. A nipple as recited in claim 2, wherein said nipple and said hole in said part have substantially the same length.

4. A nipple as recited in claim 1, wherein,
the inner and outer diameters of said hose being 2.5 and 4 mm., respectively, the inner and outer diameter of said sleeve portion being 2.5 mm and 3.0 mm., respectively, the outer diameter of said protrusions being 3.2 mm., the outer diameter of said ring portion of said nipple being 4.5 mm, and the diameter of a hole in said part being 4.2 mm.

5. An air pump facilitator for facilitating the pumping of air into an air tire comprising:
an air hose;
an air pump connecting portion for connecting one end of said hose to an air pump;
an air valve connecting portion for connecting the other end of said air hose to a Presta, Schrader or Donlup air valve; and
means for connecting said hose to said connecting portions.

6. An air pump facilitator as recited in claim 5, wherein said hose connecting means comprises:
a nipple, said nipple comprising;
a round sleeve portion,
an outwardly facing radial ring portion integrally formed with said sleeve portion along one end thereof, and
at least one cone shaped protrusion integrally formed with said sleeve portion along the outer surface thereof,
said nipple having a through hole formed through the centre thereof, so that when said sleeve portion of said nipple is inserted into one end of said hose and said hose is pulled back through a hole in said connecting portions, said hose is permanently locked inside said portions providing a hermetic seal therebetween.

7. A facilitator as recited in claim 6, wherein said air pump connecting portion comprises:
a first, second and third cylindrical portions integrally formed with each other, said second cylindrical portion having an inner diameter which is larger than the inner diameter of said first cylindrical portion and said third cylindrical portion having an inner diameter which is larger than the inner diameter of said second cylindrical portion,
the outer diameter of said third cylindrical portion being substantially the same as the diameter of a hole in a rubber sleeve portion in a conventional air pump and the length of said third cylindrical portion being shorter than the length of the hole in said rubber sleeve in said conventional air pump, and
said hose being connected to said air pump connecting portion by;
a) first feeding one end of said hose through said holes in said cylindrical portions,
b) then inserting the sleeve portion of said nipple into the hole in said extending end of said hose until said ring portion butts up against the extending end of said hose, and
c) then pulling the hose back through said cylindrical portions until said extending end of said air hose having said sleeve portion inserted therein is locked in said first and second cylindrical portions.

8. A facilitator as recited in claim 6, wherein said air pump connecting portion comprises:
a cylindrical portion 40b having at least one cone shaped radial protrusions 40p integrally formed therewith along the outer surface thereof, the bigger diameter portion of said cone shaped protrusions 40p facing the back end 4000b of the cylindrical portion 40b,
the inner diameter of the hole 40h2 in the cylindrical portion 40b being the same or slightly larger than the outer diameter of the hose 23,
the outer diameter of the cylindrical portion 40b being 5.0 mm and the outer diameter of the protrusions 40p being 5.2 mm,
the inner and outer diameters of the hose 23 being 2.5 mm and 4.0 mm, respectively,
the inner and outer diameters of the sleeve portion 21s of the nipple 21 being 2.5 mm and 3.0 mm, respectively,
the outer diameter of the cone shaped protrusions 21p being 3.2 mm,
the outer diameter of the ring portion 21r being 4.5 mm
said hose being connected to said air pump connecting portion by;
a) first feeding one end of said hose through the back end of said hole in said cylindrical portion until said end of said hose extends out the front end of said cylindrical portion,
b) then inserting the sleeve portion of said nipple into the hole in said extending end of said hose until said ring portion butts up against the extending end of said hose, and
c) then pulling the hose back through said cylindrical portions until said extending end of said air hose having said sleeve portion inserted therein is locked in said cylindrical portions.

9. A facilitator as recited in claim 5, wherein:
said air valve connecting portion comprises a Schrader type air valve connector, which comprises:
a first part comprising:
a cylindrical portion 51c having a thread 51t formed along the inner wall thereof and an inwardly facing radial ring portion 51r integrally formed with the cylindrical portion 51c along one end thereof, said ring portion 51r having a through hole 51h formed through the centre thereof;
a second part comprising:
a first, second and third concentric cylindrical portion 52a, 52b and 52c integrally formed with each other, the second cylindrical portion 52b having a larger inner diameter than the first cylindrical portion 52a and the third cylindrical portion 52c having a larger inner diameter than said second cylindrical portion 52b,
said third cylindrical portion 52c having an outwardly facing ring portion 52r integrally formed therewith along the extending end thereof,
the outer diameters of the ring portion 52r being slightly smaller than the inner diameters of the cylindrical portion 51c of the first part 51, the outer diameters of the ring portion 52r being larger than the hole 51h in the ring portion 51r of the first part 51,
the third cylindrical portion 52c of said second part 52 having an outer diameter which is slightly smaller than the size of the hole 51h in the ring portion 51r of said first part 51,
a third part comprising:
a round shaft 53a having two axial slots 53s formed therein in the axial direction thereof, the shaft 53a further having a round groove 53g formed therein in the radial direction thereof for mounting a conventional rubber O ring 151 therein,
the shaft 53a on the back end 53b of the radial groove 53g having an outer diameter which is slightly larger than the inner diameter 52d3 in the third cylindrical portion 52c of the second part 52, so that the back end 53b of the shaft 53s may be pressure fitted into said third cylindrical portion 52c,
the shaft 53a on the front end 53f of the radial groove 53g having an outer diameter which is smaller than the hole inside a Schrader air valve 17, so that the front end 53f of the shaft 53a can slide thereinto to press on the air release valve 17p inside the Schrader air valve 17, and
a fourth part comprising:
a round diaphragm mounted inside said third cylindrical portion of said second part for allowing air to flow only in one direction through said Schrader type air valve.

10. A facilitator as recited in claim 5, wherein said air valve connecting portion comprises a Presta type air valve connector comprising:
a first part 61 which comprises:
a cylindrical shaped shaft portion 61c having a front hole 61h1 formed at the front end 61f thereof and a cylindrically shaped back hole 61h2 formed through the back end 61b thereof;
a thread portion 61t formed in the central portion of the cylindrical shaft portion 61c;
a groove 61g for housing an O ring 152 therein formed on the inside walls of the said shaft portion 61c between the front hole 61h and the thread portion 61t,
the front hole 61f being slightly larger than the shaft portion 18s of the Presta air valve 18, the thread portion 61t having the same diameter and pitch as the thread 18t on the front end of a conventional Presta type air valve 18,
the back hole 61h2 extending from the back end 61b of the cylindrical portion 61c to the back end of the thread portion 61t,
the inner diameter of the hole 61h2 being larger than the inner diameter of the thread portion 61t,
a second part 62 which comprises:
a first, second and third cylindrical portions coaxially formed with each other, the inner diameter of the second cylindrical portion 62b being larger than the inner diameter of the first cylindrical portion 62a and the inner diameter of the third cylindrical portion 62c being larger than the inner diameter of the second cylindrical portion 62b,
a first and second outwardly facing radial rings 62r1, 62r2 integrally formed with the third cylindrical portion 62c along the outer surface thereof, the first ring 62r1 being formed on the extending end of the third cylindrical portion 62c and the second ring 62r2 being formed along a central portion of the third cylindrical portion 62c,
the rings 62r1, 62r2 and the portion of the third cylindrical portion 62c between the rings 62r1 and 62r2 providing a space for housing an O ring 153 therebetween,
the inner diameter of the hole 62d3 in the cylindrical portion 62c being larger than the outer diameter of the release nut 18n of the Schrader type air valve 18, so that the release nut 18n can fit therein,
the length of the cylindrical portion 62c of the second part 62 being slightly longer than the pin 18p of the Presta air valve, so that the pin 18p and the nut 18n can fit therein,
the outer diameter of the rings 62r1 and 62r2 of the cylindrical portion 62a being slightly smaller than the inner diameter of the hole 61h in the first part 61,
the length of the hole 61h2 being longer than the axial distance between the outer surfaces of the two radial rings 62r1 and 62r2,
so that said rings 62r1 and 62r2 of said second part can be inserted into said hole 61h2 and the extending ends 61e of said first part 61 can be bent around the second ring portion 62r2 to permanently join said first part 61 and said second part 62 to each other while allowing said parts can swivel with respect to each other,
said hose connecting means comprising:
a nipple, said nipple having a cylindrical sleeve portion 21s and a ring portion 21r integrally formed therewith along one end thereof, said sleeve portion having at least one cone shaped protrusion integrally formed therewith along the outer surface thereof, said nipple having a through hole formed through the centre thereof, so that when the sleeve portion of said nipple is inserted into one end of said hose and said hose is pulled back through the holes in said first and said second parts 61 and 62, the end of the hose having said sleeve portion of said nipple inserted therein becomes permanently locked inside said first and second cylindrical portions 62a, 62b of said second part 62, providing a hermetic seal therebetween.

11. A facilitator as recited in claim 10, wherein:
the inner and outer diameters of said air hose are 2.5 mm and 4 mm, respectively,
the inner diameter of the first and second cylindrical portion 62a and 62b is 4.0 mm and 4.2 mm, respectively, and
the inner and outer diameter of said sleeve portion 21s of said nipple 21 are 2.5 mm and 3.0 mm, respectively, and
the outer diameter of said protrusion being 3.2 mm and the outer diameter of said ring portion 21r of said nipple 21 is 4.5 mm.

12. A facilitator as recited in claim 5, wherein said air valve connecting portion comprises a REVERSIBLE type air valve connector comprising:
a first part 71 which comprises:
a first, second and third cylindrical portions coaxially formed with each other, the inner diameter of the second cylindrical portion 71b being larger than the inner diameter of the first cylindrical portion 71a and the inner diameter of the third cylindrical portion 71c being larger than the inner diameter of the second cylindrical portion 71b,
a first and second outwardly facing radial rings 71r1, 71r2 integrally formed with the third cylindrical portion 71c along the outer surface thereof, the first ring 71r1 being formed on the extending front end of the third cylindrical portion 71c and the second ring 71r2 being formed along a central portion of the third cylindrical portion 71c,
the rings 71r1, 71r2 and the portion of the third cylindrical portion 71c between the rings 71r1 and 71r2 providing a space for housing an O ring 154 therebetween,
a second part which comprises:
a cylindrical portion 72c having a round inner radial ring 72r integrally formed therewith along the inner central surface thereof; and
a thread portion 72t formed at the front end 72f of the cylindrical portion 72c on the inner surface thereof;
a radial groove 72g formed in the inner wall of the cylindrical portion 72c between the inner end of the thread portion 72t and the front side of the ring 72r, said groove 72g housing an O ring 155 therein,
the cylindrical portion 72c on the back end of the ring 72r having a cylindrical hole 72h1 the inner surface of which is smooth,
the outer diameter of the rings 71r1 and 71r2 of the first part 71 being slightly smaller than the inner diameter of the hole 72h1 in the back end 72b of the second part 72 so that the rings 71r1 and 71r2 can be inserted into the hole 72h1 up to the point where the ring 71r1 of the first part 71 is adjacent to the back side of the ring portion 72r,
the length of the hole 72h1 in the cylindrical portion 72c being longer than the axial distance between the rings 71r1 and 71r2 of the first part 71, so that the rings 71r1 and 71r2 can be completely inserted inside the hole 72h in the second part 72 and so that the extending ends 72e of the cylindrical portion 72c in the back end 72b of the second part 72 extending past the rings 71r2 and 71r1 can be folded to permanently couple the parts 71 and 72 to each other while allowing said parts to rotate with respect to each other,
a third part 73 which comprises:
a cylindrical portion 73c having thread 73t1 and 73t2 formed on the outer surface thereof, the thread portion 73t1 extending from a Presta end 73p of the cylindrical portion 73 partly towards the centre of the cylindrical portion 73c and the thread 73t2 extending from a Schrader end 73s of the cylindrical portion 73c partly towards the centre of the cylindrical portion 73c,
said Presta end 73p having a hole 73h1 formed through the centre thereof, the hole 73h1 having an inner diameter which is slightly larger than the outer diameter of the shaft portion 18s of a Presta air valve,
a Presta thread portion 73t3 formed on the inner surface of the cylindrical portion 73c and a radial groove 73g for housing an O ring 156 therein formed on the inner surface of the cylindrical portion 73c, the radial groove 73g being formed between the Presta end 73p and the thread portion 73t,
the groove 73g being formed about 0.5 mm from the Presta end 73p of the cylindrical portion 73c and the Presta thread portion 73t3 being formed adjacent to the groove 73g,
the Presta thread 73t3 is substantially 5 mm long and extends from the inner side of the groove 73g into the centre of the cylindrical portion 73c,
a Schrader thread portion 73t4 formed on the inner walls of the cylindrical portion 73 along the Schrader end 73s thereof,
the Schrader thread portion 73t4 extending from the Schrader end 73s for substantially 10 mm into the center of the cylindrical portion 73c,
a cylindrical hole 73h2 formed inside the central portion of the cylindrical portion 73c, said hole 73h2 extending from the inner side of the Presta thread portion 73t3 to the inner side of the Schrader thread portion 73t4, the diameter of the hole 73h2 being larger than the inner diameter of the Presta thread portion 73t3 and smaller than the inner diameter of the Schrader thread portion 73t4.
the Presta thread portion 73t3 being provided for receiving a Presta type air valve 18 therein and the Schrader thread portion 73t4 being provided for receiving a Schrader type air valve 17 therein,
a fourth part 74 which comprises:
a round shaft portion 74a having two axial grooves 74s formed along the outer surface thereof in the axial direction thereof on opposing sides thereof,
a round outwardly facing radial ring portion 74r integrally formed with the shaft portion 74a along a front end 74f of the shaft portion 74a,
a taper 74t formed on the back end 74b of the shaft portion 74a for facilitating the insertion of the shaft portion 74a into the third cylindrical portion 71c of the first part 71, the outer diameter of the shaft 74a of the fourth part 74 being slightly larger than the inner diameter of the hole 71d3 in third cylindrical portion 71c of the first part 71, so that it may be frictionally inserted therein,
the ring portion 74r preventing the shaft portion 74a from being inserted therebeond into the cylindrical portion 71c of the first part 71, the outer diameter of the ring portion 74r in the part 74 being smaller than the inner diameter of the hole 72h2 in the ring portion 72r in the second part 72,
a fifth part 75 which comprises:
a round shaft portion 75a having two axial slots 75s formed therein in the axial direction thereof, the slots 75s extending from the front end 75f to the back end 75b of the shaft 75a,
a radial groove 75g formed along a central portion of the shaft portion 75 in the radial direction thereof for mounting a conventional rubber O ring 151 therein,
an outwardly extending radial ring 75r integrally formed with the shaft 75a along the outer surface thereof and on the back side of the radial groove 75g,
the outer diameter of the shaft 75a on the back end 75b of the radial groove 75g being slightly larger than the the diameter of the hole 73h2 in the third part 73, so that the back end of the shaft 75a can be frictionally inserted therein,
the back end 75b of the shaft 75a being tapered 75t to facilitate the insertion of the back end 75b of the shaft portion 75a into the hole 73h2 in the third part 73,
the front end 75f of the shaft 75a and the ring 75r having an outer diameter which is smaller than the diameter of the thread 73t4 in the third part 73, and
the front end 75f of the shaft 75a having an outer diameter which is smaller than the hole inside a Schrader air valve 17, so that the shaft 75a can slide thereinto to press on the air release pin 17p inside the Schrader air valve 17,
an O ring 154 mounted on the third cylindrical portion 71c between the rings 71r1 and 71r2 for blocking air from escaping between the first part 71 and the second part 72 when pumping air therethrough,
an O ring 155 mounted in the groove 72g of the second part 72 for preventing air from escaping between the second part 72 and the third part 73,
an O ring 151 mounted in the groove 75g of the fifth part 75 for preventing air from escaping while pumping air into the Scharder type air valve, and
an O ring 156 mounted in the groove 73g of the third part 73 for preventing air from escaping while pumping air into the Presta type air valve,

13. A facilitator as recited in claim 5, further comprising:
an INLINE air pressure gauge mounted along a central portion of said air hose, which comprises:
a transparent outer cylindrical portion 81 having a first, second and third concentric cylindrical holes 81h1, 81h2 and 81h3 formed therein, the first hole 81h1 being adjacent to the second hole 81h2 and the second hole 81h2 being adjacent to the third hole 81h3,
the first hole 81h1 extending from the front end 81f of the cylindrical portion 81 and the third hole 81h3 extending from the back end 81b of the outer cylindrical portion 81,
the third hole 81h3 has the same diameter as the outer diameter of the hose 23,
the second hole 81h2 is slightly larger than the outer diameter of the air hose 23 but smaller than the diameter of the air hose 23 when the sleeve portion 21s of the nipple 21 is inserted thereinto,
the outer diameter of the sleeve portion 21s and the protrusions 21p of the nipple 21 having a smaller outer diameter than the diameters of the second and first holes 81h2 and 81h1 in the outer cylindrical portion 81.
the outer diameter of the ring portion 21r of the nipple 21 is larger than the second hole 81h2 and smaller than the first hole 81h1 in the outer cylindrical portion 81, so that the second and third holes 81h3 and 81h2 in the end of the cylindrical portion 81, in conjunction with the nipple 21 surve the purpose of air hose attaching means 100,
a cap portion which comprises:
a round sleeve portion 82s having a outwardly facing radial ring portion 82r integrally formed therewith along a back end 82b thereof,
the outer diameter of the sleeve portion 81s of the cap portion 82 is the same as the inner diameter of the hole 81h1 in the outer cylindrical portion 81,
the outer diameter of the ring portion 82r of the cap portion 82 is the same as the outer diameter of the cylindrical portion 81.
the cap portion 82 further comprises; a first and a second concentric holes 82h2 and 82h3 formed therethrough, the first hole extending from the front end 82f of the cap portion 82 to a central point therein and the second hole 82h3 extending from the back end 82b of the cap portion 82 to the inner end of the first hole 82h2,
the second hole 82h3 has the same diameter as the outer diameter of the hose 23,
the first hole 82h2 is slightly larger than the outer diameter of the air hose 23 but smaller than the diameter of the air hose 23 when the sleeve portion 21s of the nipple 21 is inserted thereinto,
the outer diameter of the sleeve portion 21s and the protrusions 21p of the nipple 21 have a smaller outer diameter than the inner diameters of the second and first holes 82h2 and 82h3 in the cap portion 82,
the outer diameter of the ring portion 21r of the nipple 21 has a larger outer diameter than the first and second hole 82h2, 82h3, so that the first and second holes 82h2 and 82h3 in the cap portion 82, in conjunction with the nipple 21 surve the purpose of air hose attaching means 100,
an inner transparent cylindrical portion 83 having an open front end 83f and a closed back end 83b,
the outer diameter of the inner cylindrical portion 83 being smaller than the inner diameter of the hole 81h1 in the outer cylindrical portion 81, so that the inner cylindrical portion 83 can be inserted into the outer cylindrical portion 81 as well as allow air to flow therebetween,
a pair of round protrusions 83p formed on the back end of the closed end 83b of the inner cylindrical portion 83 for ensuring that air can flow between the inner and outer cylindrical portions,
The length of the inner cylindrical portion 83 being shorter than the outer cylindrical portion 81, so that the inner cylindrical portion 83 can fit inside the cylindrical hole 81h1 in the outer cylindrical portion 81 even when the sleeve 82s of the cap portion 82 is completely inserted into the open front end 81f of the outer cylindrical portion 81,
a piston 12 which comprises:
a round shaft portion 12s having a cylindrical shaped opening 12h formed therein extending from the front end 12f thereof partially therethough to the back end 12b thereof,
a pair of round outwardly facing radial rings integrally formed with the shaft portion 12s along the outer surface thereof.
the shaft 12s has an outer diameter which is smaller than the inner diameter 83h of the inner cylindrical portion 83,
the outer diameters of the rings 12r1, 12r2 being the same as or slightly larger than the inner diameter 83h of the inner cylindrical portion 83, so that the rings 12r1, 12r2 of the piston 12 frictionally slide inside the cylindrical portion 83 while not allowing air to pass between the rings 12r1 and 12r2 of the piston 12 and the inner walls 83h of the inner cylindrical portion 83,
the INLINE air gauge being connected to the facilitator 45 or 46 by:
first cutting the air hose 23 at a central point thereof between the air pump connecting portion 40 and the air valve connecting portion 50, 60 or 70, into two halves 23a and 23b,
then inserting the first extending end 23a of the hose 23 into the holes 82h3, 81h2 through the back end 82b of the cap portion 82 until the extending end 23a extends out of the front end 82f of the cylindrical cap portion 82,
then pressing the sleeve portion 21s of the nipple 21 into the hole in the extending end of the hose 23a until the ring portion 21r of the nipple 21 butts up against the extending end of the hose 23a,
then pulling back on the hose 23 until the end of the hose 23b and the nipple 21 inserted therein are hermetically locked inside the holes 82h2, 82h3,
then inserting the second extending end 23b of the hose 23 into the holes 81h3, 81h2, 81h1 through the back end 81b of the outer cylindrical portion 81 until the extending end 23b extends out of the front end 81f of the cylindrical portion 81,
then pressing the sleeve portion 21s of the nipple 21 into the hole in the extending end of the hose 23b until the ring portion 21r of the nipple 21 butts up against the extending end of the hose 23b,
then pulling back on the hose 23 until the end of the hose 23b and the nipple 21 inserted therein are hermetically locked inside the holes 81h2, 81h3, of the outer cylindrical portion 81,
then applying a lubricant to the outer surface of the piston 12 and the inner walls of the inner cylindrical portion 83,
then inserting the piston 12 into the front end 83f of the inner cylindrical portion 83 with the back end 12b of the piston 12 facing the back end 83b of the inner cylindrical portion 83,
then applying an adhesive material to the shaft portion 82s of the cap portion 82, and
then inserting the shaft portion 82s of the cap portion 82 into the front end 81f of the outer cylindrical portion 81 until the ring portion 82r of the cap portion 82 butts up against the front end 81f of the outer cylindrical portion 81.

14. A facilitator as recited in claim 5, further comprising:
a digital INLINE air pressure gauge mounted along a central portion of said air hose, which comprises:
a transparent outer cylindrical portion 81 having a first, second and third concentric cylindrical holes 81h1, 81h2 and 81h3 formed therein, the first hole 81h1 being adjacent to the second hole 81h2 and the second hole 81h2 being adjacent to the third hole 81h3,
the first hole 81h1 extending from the front end 81f of the cylindrical portion 81 and the third hole 81h3 extending from the back end 81b of the outer cylindrical portion 81,
the third hole 81h3 having the same diameter as the outer diameter of the hose 23,
the second hole 81h2 being slightly larger than the outer diameter of the air hose 23 but smaller than the diameter of the air hose 23 when the sleeve portion 21s of the nipple 21 is inserted thereinto,
the outer diameter of the sleeve portion 21s and the protrusions 21p of the nipple 21 having a smaller outer diameter than the diameters of the second and first holes 81h2 and 81h1 in the outer cylindrical portion 81.
the outer diameter of the ring portion 21r of the nipple 21 being larger than the second hole 81h2 and smaller than the first hole 81h1 in the outer cylindrical portion 81, so that the second and third holes 81h3 and 81h2 in the end of the cylindrical portion 81, in conjunction with the nipple 21 surve the purpose of air hose attaching means 100,
a cap portion which comprises:
a round sleeve portion 82s having a outwardly facing radial ring portion 82r integrally formed therewith along a back end 82b thereof,
the outer diameter of the sleeve portion 81s of the cap portion 82 being the same as the inner diameter of the hole 81h1 in the outer cylindrical portion 81,
the outer diameter of the ring portion 82r of the cap portion 82 being the same as the outer diameter of the cylindrical portion 81.
the cap portion 82 having;
a first and a second concentric holes 82h2 and 82h3 formed therethrough, the first hole 82h2 extending from the front end 82f of the cap portion 82 to a central point therein and the second hole 82h3 extending from the back end 82b of the cap portion 82 to the inner end of the first hole 82h2,
the second hole 82h3 has the same diameter as the outer diameter of the hose 23,
the first hole 82h2 is slightly larger than the outer diameter of the air hose 23 but smaller than the diameter of the air hose 23 when the sleeve portion 21s of the nipple 21 is inserted thereinto,
the outer diameter of the sleeve portion 21s and the protrusions 21p of the nipple 21 have a smaller outer diameter than the inner diameters of the second and first holes 82h2 and 82h3 in the cap portion 82,
the outer diameter of the ring portion 21r of the nipple 21 has a larger outer diameter than the first and second hole 82h2, 82h3, so that the first and second holes 82h2 and 82h3 in the cap portion 82, in conjunction with the nipple 21 surve the purpose of air hose attaching means 100,
a cylindrically shaped electronic pressure measuring device inserted into the hole 81h1 inside the outer cylindrical portion 81,
the outer diameter of the electronic device being smaller than the inner diameter of the hole 81h1 in the outer cylindrical portion 81, so that air can flow therebetween,
the length of the electronic device being shorter than the outer cylindrical portion 81, so that the device can fit inside the cylindrical hole 81h1 in the outer cylindrical portion 81 even when the sleeve 82s of the cap portion 82 is completely inserted into the open front end 81f of the outer cylindrical portion 81,
the INLINE air gauge being connected to the facilitator 45 or 46 by:
first cutting the air hose 23 at a central point thereof between the air pump connecting portion 40 and the air valve connecting portion 50, 60 or 70, into two halves 23a and 23b,
then inserting the first extending end 23a of the hose 23 into the holes 82h3, 81h2 through the back end 82b of the cap portion 82 until the extending end 23a extends out of the front end 82f of the cylindrical cap portion 82,
then pressing the sleeve portion 21s of the nipple 21 into the hole in the extending end of the hose 23a until the ring portion 21r of the nipple 21 butts up against the extending end of the hose 23a,
then pulling back on the hose 23 until the end of the hose 23b and the nipple 21 inserted therein are hermetically locked inside the holes 82h2, 82h3,
then inserting the second extending end 23b of the hose 23 into the holes 81h3, 81h2, 81h1 through the back end 81b of the outer cylindrical portion 81 until the extending end 23b extends out of the front end 81f of the cylindrical portion 81,
then pressing the sleeve portion 21s of the nipple 21 into the hole in the extending end of the hose 23b until the ring portion 21r of the nipple 21 butts up against the extending end of the hose 23b,
then pulling back on the hose 23 until the end of the hose 23b and the nipple 21 inserted therein are hermetically locked inside the holes 81h2, 81h3, of the outer cylindrical portion 81,
then inserting the electronic device inside the hole 81h1 in the outer cylindrical portion 81,
then applying an adhesive material to the shaft portion 82s of the cap portion 82, and
then inserting the shaft portion 82s of the cap portion 82 into the front end 81f of the outer cylindrical portion 81 until the ring portion 82r of the cap portion 82 butts up against the front end 81f of the outer cylindrical portion 81.

15. An air pump facilitator as recited in claim 14, wherein said digital air pressure indicating means comprises:
a transducer for converting the air pressure inside said outer cylindrical portion into a electric signal;
A/D converting means for converting the analog signal from said transducer to a digital signal representative of the pressure inside said outer cylinder portion; and
digital display means connected to said converting means for displaying the pressure inside said outer cylinder portion.

16. A facilitator as recited in claim 5, wherein said air pump connecting portion comprises:
a cylindrical portion the inner diameter of which is substantially same as the outer diameter of said hose and the outer diameter of which is substantially 5 mm, said cylindrical portion having at least one radial cone shaped protrusion integrally formed therewith along the outer surface thereof, and
said air hose connecting means comprising a nipple, said nipple comprising a cylindrical sleeve portion having at least one cone shaped protrusion integrally formed therewith along the outer surface thereof, and an outwardly facing ring portion integrally formed with said sleeve portion along one end thereof, said sleeve portion having an outer diameter which is bigger than the outer diameter of said cone shaped protrusions, so that when one end of said hose is inserted into said cylindrical portion and said sleeve portion is inserted into said one end of said hose, when said hose having said sleeve portion inserted therein is pulled back through said hose, said hose and said nipple become permanently locked in said cylindrical portion forming a hermetic seal therebetween, whereby said cylindrical portion can be inserted into a hole in a conventional rubber portion in a conventional air pump normally used for mounting a Presta type air valve.
